(19) United States
(12) Patent Application Publication
(10) Pub. No.: US 2004/0194511 A1
(43) Pub. Date: Oct. 7, 2004

(54) Sol-gel-derived halogen-doped glass

(76) Inventors: Chih-Hsing Cheng, Fullerton, CA (US); Dengfeng Xu, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/771,176

(22) Filed: Feb. 3, 2004

Related U.S. Application Data
(63) Continuation-in-part of application No. 10/215,162, filed on Aug. 7, 2002.
Application No. 10/215,162 is a continuation-in-part of application No. 10/062,748, filed on Feb. 1, 2002.

(51) Int. Cl. C03B 37/016; C03C 3/06

(52) U.S. Cl. 65/395; 501/54; 65/440; 65/17.2

(57) ABSTRACT

A method of fabricating a halogen-doped glass includes providing a gel monolith having a first halogen content. The method further includes reducing an impurity concentration of the gel monolith. The method further includes consolidating the gel monolith into a glass having a second halogen content. The second halogen content is less than or equal to the first halogen content. A halogen-doped glass has a fluorine content in a range between approximately 0.5 wt. % and approximately 4 wt. %, a chlorine content less than 100 parts per million, and an OH content less than one part per million.

### CLAIM OF PRIORITY

This application is a continuation-in-part of, and claims priority from, U.S. patent application Ser. No. 10/215,162, filed Aug. 7, 2002, which is incorporated in its entirety by reference herein and is a continuation-in-part of, and claims priority from, U.S. patent application Ser. No. 10/062,748, filed Feb. 1, 2002, which is incorporated in its entirety by reference herein. This application also claims the benefit of U.S. Provisional Application No. ______ (Attorney Ref. SITECH.037PR), filed Feb. 2, 2004, which is incorporated in its entirety by reference herein.

### RELATED APPLICATIONS

This application is related to U.S. patent application Ser. No. 10/062,613, filed Feb. 1, 2002, and U.S. patent application Ser. No. 10/062,746, filed Feb. 1, 2002, each of which is incorporated in its entirety by reference herein.

### BACKGROUND OF THE INVENTION

1. Field of the Invention

This invention relates to optical components with selected properties (e.g., chemical purity, homogeneity) compatible with a variety of applications, including high-performance optical systems, and method of fabricating such optical components.

2. Description of the Related Art

High-performance oxide-based materials are increasingly in demand for use in a variety of optical applications. For example, silica glass has the optical transmittance, mechanical hardness, chemical durability, thermal stability, low thermal expansion, and high laser damage threshold which make it an optimal material for applications such as photomasks for semiconductor photolithography processing, optoelectronic laser diodes, fiber optic telecommunications, medical laser delivery systems, and military optical sensors. There is significant pressure on manufacturers to find materials and fabrication techniques which can satisfy the increasingly stringent performance requirements of these and other high-performance optical systems.

Numerous techniques are currently in use for the fabrication of glasses or ceramics. For example, silica glasses have traditionally been manufactured by melting natural quartz or synthetic silica in crucibles at high temperatures (typically about 1700 degrees Celsius-2000 degrees Celsius). However, the resultant materials have limited utility for various optical applications, primarily due to structural inhomogeneities as well as impurity concentrations (e.g., from intrinsic impurities in the raw materials, incomplete chemical reactions of components, and contamination by the crucible). Such high-temperature processes are also unsuitable for manufacturing products with certain compositions, tailored dopant or additive gradients, organic or high vapor pressure additives, or additives in their metallic or partially reduced states.

Another more recent technique for manufacturing silica glasses has been chemical vapor deposition (CVD), in which silicon-containing chemical vapors are combined with oxygen under high temperature conditions to deposit silica onto a substrate. However, the resultant materials are relatively expensive due to low material collection efficiencies, slow processing rates, and complex processing and pollution control equipment. Furthermore, CVD processes lack the versatility for fabricating more compositionally complex glasses.

Sol-gel technology has been used to fabricate products which satisfy some or all of the desired performance requirements without the difficulties or limitations found in more conventional fabrication techniques. A typical sol-gel silica process involves the transition of a liquid colloidal solution “sol” phase into a solid porous “gel” phase, followed by drying and consolidating (i.e., sintering) the resulting gel monolith at elevated temperatures to form silica glass. One method of preparing a silica porous gel monolith is to pour into a mold a solution of silica-forming compounds (e.g., silicon alkoxides), solvents, and catalysts, which then undergoes hydrolysis and polymerization, resulting in a wet porous gel monolith or matrix. After drying the wet gel monolith in a controlled environment to remove the fluid from the pores, the dry gel monolith is densified into a solid glass-phase monolith.

Sol-gel technology can yield products with the desired chemical purity, homogeneity, and flexibility in compositions, dopants, and dopant profiles. However, the potential for sol-gel processes for fabricating large monoliths has been limited by various problems. Large gel monoliths can take a long time to dry, thereby limiting the product throughput. But even more importantly, shrinkage of the gel monolith during the drying process often results in cracking, especially in larger gel monoliths.

As outlined by Pope, et al. in U.S. Pat. No. 5,023,208 and Wang, et al. in U.S. Pat. No. 5,264,197, both of which are incorporated by reference herein, this resultant cracking of gel monoliths during the drying step of the fabrication process is believed to result from stresses due to capillary forces in the gel pores. Numerous techniques for reducing this cracking have been proposed, and many of these efforts have focused on increasing the pore sizes of the gel monolith to reduce the capillary stresses generated during drying. Pope, et al. discloses subjecting the gel to a hydrothermal aging treatment which causes silica monomers to migrate from small pores to silica particle surfaces in the porous gel matrix, thereby increasing the average pore diameter. Wang, et al. discloses adjusting the relative concentrations of an alcohol diluent and/or one or more catalysts such as HCl or HF, which has the effect of increasing the average pore radius of the resulting dry gel. HF catalyzed gels generally have larger pore sizes than gels catalyzed by other catalysts such as HCl, HNO₃, H₂SO₄, or oxalic acid.

### SUMMARY OF THE INVENTION

Certain embodiments provide a method of fabricating a halogen-doped glass. The method comprises providing a gel monolith having a first halogen content. The method further comprises reducing an impurity concentration of the gel monolith. The method further comprises consolidating the gel monolith into a glass having a second halogen content. The second halogen content is less than or equal to the first halogen content.

Certain embodiments provide a method of fabricating a halogen-doped glass. The method comprises providing a gel monolith having a first halogen content. The method further comprises reducing an impurity concentration of the gel monolith. The method further comprises heating the gel monolith to an elevated temperature sufficient to sinter the gel monolith into a glass having a second halogen content. The second halogen content is less than or equal to the first halogen content.

Certain embodiments provide a method of fabricating a halogen-doped glass. The method comprises consolidating a gel monolith having a halogen content. The method further comprises reducing the liberation of halogen from the gel monolith during the consolidation by exposing the gel monolith to a halogen-containing glass during the consolidation.

Certain embodiments provide a method of fabricating a fluorine-doped silica glass. The method comprises consolidating a gel monolith having a fluorine content in an environment with an elevated fluorine partial pressure.

Certain embodiments provide a silica glass having a fluorine content in a range between approximately 0.5 wt. % and approximately 4 wt. %, a chlorine content less than 100 parts per million, and an OH content less than one part per million.

### BRIEF DESCRIPTION OF THE DRAWINGS

These aspects and other aspects of embodiments of the present invention will be apparent to the skilled artisan from the following detailed description read in conjunction with the appended drawings, which are meant to illustrate, and not to limit, the invention, and in which:

FIG. 1 is a flow diagram of a method of forming a gel monolith in accordance with an embodiment of the present invention.

FIG. 2 is a flow diagram corresponding to another embodiment of the present invention in which the first solution is formed by mixing metal alkoxide with a solvent and cooling the first solution.

FIGS. 3A-3F schematically illustrate various embodiments of the present invention in which the first solution is mixed and cooled.

FIG. 4 is a flow diagram corresponding to another embodiment of the present invention in which the second solution is formed by mixing the catalyst with water and cooling the second solution.

FIG. 5 is a flow diagram corresponding to another embodiment of the present invention in which the metal alkoxide is cooled to a first temperature, the second solution is formed by mixing the catalyst, solvent, and water, and cooling the second solution.

FIG. 6 is a flow diagram corresponding to another embodiment of the present invention in which the third solution is formed by mixing the first solution and the second solution, and cooling the third solution.

FIG. 7 schematically illustrates a mixing station in accordance with embodiments of the present invention.

FIG. 8 schematically illustrates an alternative mixing station in accordance with embodiments of the present invention.

FIG. 9 schematically illustrates the dependence of the refractive index of fluorine-doped silica glass as a function of fluorine concentration for an exemplary system.

FIG. 10 is a flow diagram of an embodiment of a method of preparing a solution for forming a halogen-doped gel monolith.

FIGS. 11A-11C are flow diagrams of alternative embodiments of forming a solution comprising the halogen.

FIG. 12 is a flowchart of a procedure for preparing components of a mold for casting in accordance with embodiments of the present invention.

FIG. 13A schematically illustrates a mold in accordance with embodiments of the present invention.

FIG. 13B schematically illustrates a mold and plug in accordance with embodiments of the present invention.

FIG. 14 schematically illustrates a gel monolith comprising pores filled with liquid, an inner region, and an outer region.

FIG. 15 is a flow diagram of a method of processing a gel monolith in accordance with embodiments of the present invention.

FIG. 16 schematically illustrates a temporal temperature profile compatible with embodiments of the present invention.

FIG. 17 is a flow diagram of an embodiment of removing a portion of the liquid from the pores of the gel monolith.

FIG. 18 is a flow diagram of an embodiment of removing substantially all of the remaining liquid from the pores of the gel monolith.

FIGS. 19A-19C schematically illustrate temporal temperature profiles comprising cycles in accordance with embodiments of the present invention.

FIG. 20 schematically illustrates an exemplary temporal temperature profile in accordance with embodiments of the present invention.

FIG. 21A graphically illustrates five pore diameter distributions in accordance with embodiments of the present invention.

FIG. 21B schematically illustrates the relationship between the pore sizes and the surface area of the pores of the gel monolith.

FIG. 22 is a flow diagram of a consolidating process in accordance with embodiments of the present invention.

FIG. 23A is a graph of the measured pore surface area of a gel monolith as a function of the consolidation temperature.

FIG. 23B is a graph of the measured pore surface area as a function of time for two selected consolidation temperatures.

FIG. 24 is a graph of the fluorine content of resultant glass monoliths as a function of the ramping rate of the consolidation temperature.

FIG. 25 is a flowchart of a method of fabricating a halogen-doped glass in accordance with embodiments of the present invention.

FIG. 26A is a flowchart of one embodiment for providing the gel monolith in accordance with the present invention.

FIG. 26B is a flowchart of one embodiment of reducing an impurity concentration of the gel monolith in accordance with the present invention.

FIG. 27A is a graph of the fluorine content (in wt. %) of the resultant glass as a function of the flow rate of SiF₄ gas during the consolidation process with a consolidation temperature ramp rate of approximately 10 degrees Celsius per hour.

FIG. 27B is a graph of the fluorine content (in wt. %) of the resultant glass as a function of the flow rate of SiF₄ gas during the consolidation process with a consolidation temperature ramp rate of approximately 50 degrees Celsius per hour.

FIG. 28A is a graph of the fluorine content of a glass monolith as a function of the pore surface area of the initial gel monolith without a fluorine-containing atmosphere during consolidation.

FIG. 28B is a graph of the fluorine content of a glass monolith as a function of the pore sizes corresponding to the pore surface areas of FIG. 28A.

FIG. 29 schematically illustrates a mechanism for fluorine doping of a gel monolith occurring at the pore surfaces.

FIG. 30 is a graph of an exemplary measured transmission spectrum for the fluorine-doped silica glass corresponding to Sample 2 of Table 3.

### DETAILED DESCRIPTION OF THE PREFERRED EMBODIMENT

Preparing A Solution

During the drying of a large gel monolith, the gel monolith shrinks in size, and capillary forces in the gel pores arise as the liquid content of the gel monolith is reduced. The tendency of gel monoliths to develop cracks is dependent on these capillary forces. For example, U.S. patent application Ser. No. 09/615,628 by Wang, et al., entitled “Sol-Gel Process for Production of Oxide-Based Glass and Ceramic Articles,” which is incorporated by reference herein, discloses a process that reduces the influence of these forces. The process comprises removing liquid from the pores of the gel monolith such that the outer region of the gel monolith is not dried before the inner region of the gel monolith is dried, thereby avoiding inhomogeneities in the capillary forces which cause stresses and cracking of the gel monolith.

Because the magnitude of the capillary forces is a function of the sizes of the pores in the gel monolith, the tendency for cracking of gel monoliths may be reduced by tailoring the gel microstructure so as to produce gel monoliths with larger pore sizes. The microstructure of a gel monolith is influenced by the rates of hydrolysis and of polymerization which occur simultaneously during the gelation of the wet gel monolith from the sol. For example, in the case of a silica-based sol in which tetraethylorthosilicate or TEOS (Si(OC₂H₅)₄) is mixed with deionized water, a diluent or solvent such as ethyl alcohol or ethanol (C₂H₅OH), and a catalyst such as HF or ammonia, hydrolysis occurs with the following reaction: Si(OC₂H₅)₄+4H₂O→4C₂H₅OH+Si(OH)₄. The Si(OH)₄ molecules polymerize, resulting in a network of SiO₂ and water. Numerous factors influence the kinetics of hydrolysis and polymerization, including the type and concentration of any catalysts and the temperature profile. The influence of the catalyst concentration on the pore sizes of the resultant gel monoliths is illustrated by Wang, et al. in U.S. Pat. No. 5,264,197. Wang, et al. disclose that increasing the HF catalyst concentration, while maintaining constant concentrations of other constituents of the sol, results in an increase in the average pore radius of the resulting dry gel.

Catalysts such as HF or ammonia increase the rate of hydrolysis and polymerization. If the catalyst concentration is too high, the hydrolysis and polymerization reactions are so fast that the gelation time is extremely short, and in certain circumstances can be nearly instantaneous. Gelation time as used herein is defined as the time from the moment a sol comprising water and a silicon-containing material such as TEOS, along with the other constituents of the sol, is prepared to the moment the sol forms a gel which does not flow. Very short gelation times do not provide sufficient time to allow a prepared sol to be filtered, poured into molds for casting, eventual gelation, and further processing. In addition, bubbles which form during the gelation process may not have an opportunity to diffuse out of the gel if the gelation time is short, thereby degrading the quality of the resulting gel. Furthermore, higher temperatures have the effect of shortening the gelation time even further.

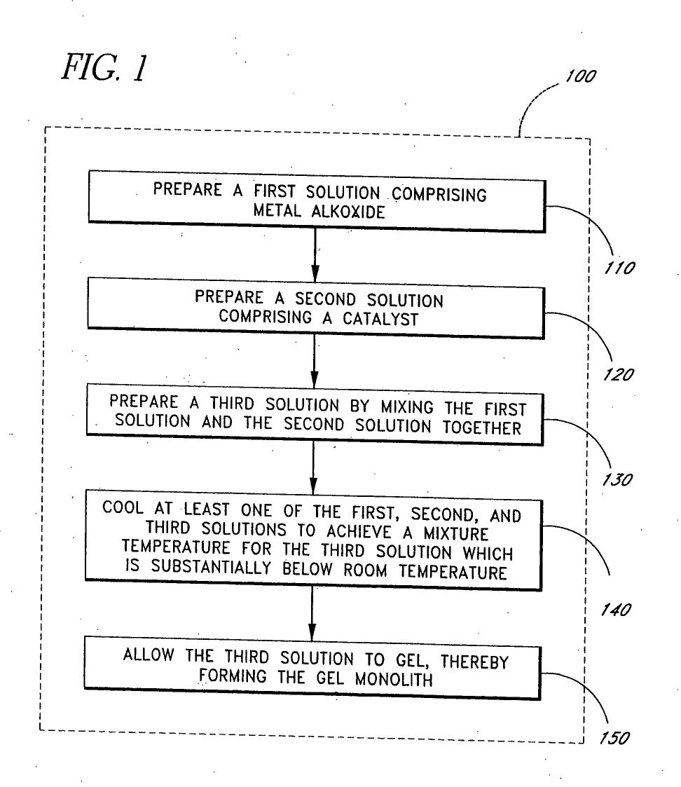

FIG. 1 is a flow diagram of a method 100 of forming a gel monolith in accordance with an embodiment of the present invention. While the flow diagram of FIG. 1 illustrates a particular embodiment with steps in a particular order, other embodiments with different orders of steps are also compatible with the present invention.

In the embodiment described in FIG. 1, in an operational block 110, a first solution 10 is prepared, the first solution 10 comprising metal alkoxide. Examples of metal alkoxides compatible with embodiments of the present invention include, but are not limited to, silicon alkoxides (such as tetramethylorthosilicate (TMOS) or tetraethylorthosilicate (TEOS)), germanium alkoxides (such as tetraethoxygermane (TEOG)), aluminum alkoxides, zirconium alkoxides, and titanium alkoxides. In certain embodiments, the first solution 10 comprises more than one metal alkoxide (e.g., both TEOS and TEOG). In certain embodiments, the first solution 10 further comprises a solvent. Examples of solvents include, but are not limited to, ethyl alcohol, methyl alcohol, or other alcohols.

In an operational block 120, a second solution 20 is prepared, the second solution 20 comprising a catalyst. Examples of catalysts include, but are not limited to, hydrofluoric acid (HF) and ammonia (NH₃). In certain embodiments, the second solution 20 further comprises a solvent, examples of which include, but are not limited to ethyl alcohol, methyl alcohol, or other alcohols.

In an operational block 130, a third solution 30 is prepared by mixing the first solution 10 and the second solution 20 together. While in certain embodiments, the second solution 20 further comprises water, in other embodiments, water is added to the third solution 30 such that the third solution 30 thereby comprises water and metal alkoxide. The third solution 30 can then begin to undergo the hydrolysis and polymerization reactions which form the gel. The presence of the catalyst in the third solution 30 accelerates the formation of the gel (i.e., reduces the gelation time of the third solution 30 as compared to the gelation time without the catalyst) as described above. In an operational block 140, at least one of the first solution 10, second solution 20, and third solution 30 is cooled to achieve a mixture temperature for the third solution which is substantially below room temperature. In certain embodiments, only the third solution 30 is cooled to achieve a mixture temperature which is substantially below room temperature. Such a mixture temperature serves to decelerate the formation of the gel, such that the third solution 30 has a significantly longer gelation time at the mixture temperature as compared to a room temperature gelation time for the third solution 30. In this way, cooling the third solution 30 to the mixture temperature makes it possible to increase the catalyst concentration in the third solution 30 while reducing the problematic effects associated with higher catalyst concentrations. In an operational block 150, the third solution 30 is allowed to gel, thereby forming the gel monolith.

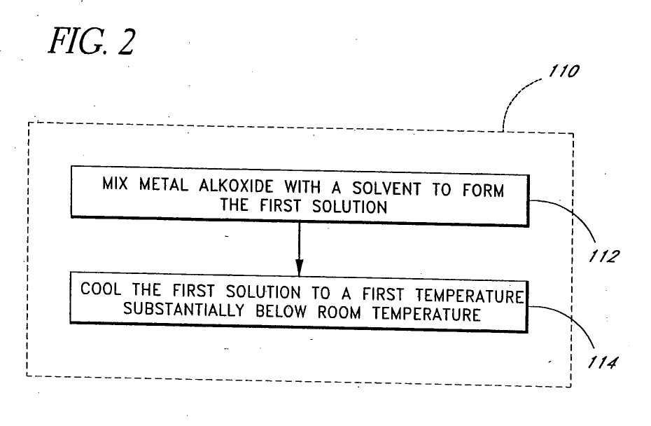

In certain embodiments, as illustrated in the flow diagram of FIG. 2, preparing 110 the first solution 10 comprises an operational block 112 in which metal alkoxide is mixed with a solvent to form the first solution 10 and an operational block 114 in which the first solution 10 is cooled to a first temperature substantially below room temperature. While FIG. 2 illustrates a particular embodiment in which mixing 112 occurs before cooling 114, in other embodiments one or both of the mixed constituents of the first solution 10 (i.e., the metal alkoxide and the solvent) can be cooled before or while being mixed together to form the first solution 10.

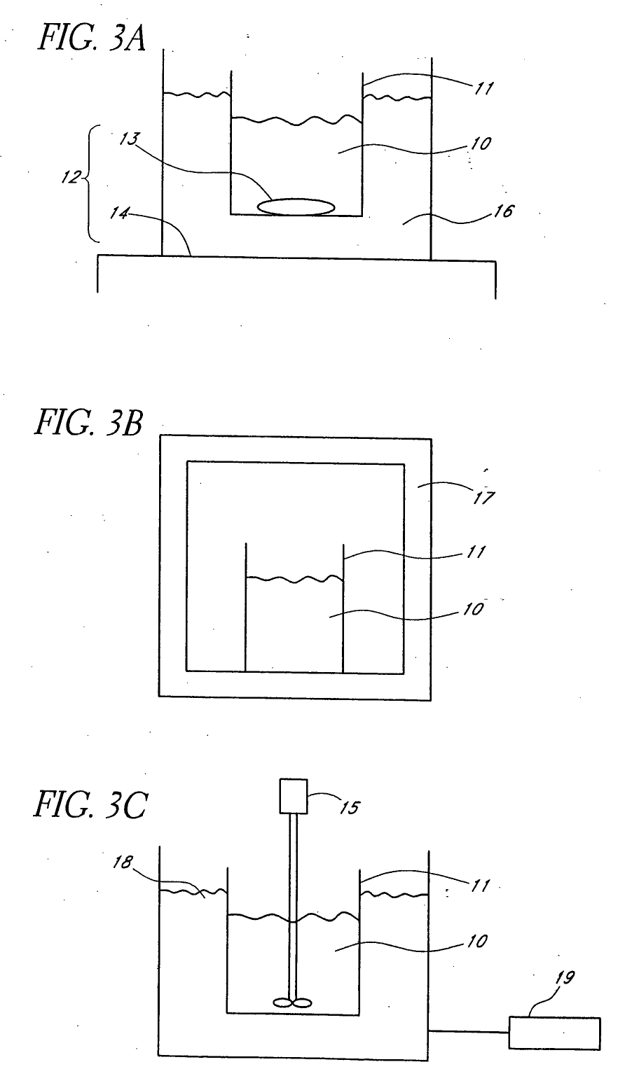

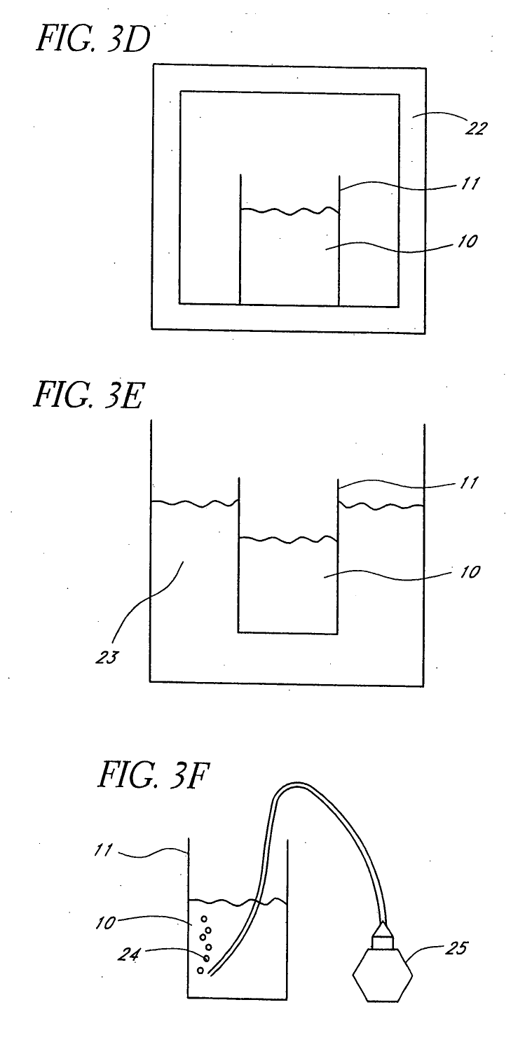

In certain embodiments, mixing 112 the metal alkoxide with the solvent is achieved by pouring both constituents of the first solution 10 into a first vessel 11. In other embodiments, a mixing system 12 is used to agitate the first solution 10 to ensure sufficiently homogeneous mixing of the metal alkoxide and the solvent. Examples of mixing systems 12 in accordance with embodiments of the present invention include, but are not limited to, magnetic stirrers, mechanical stirrers, static mixers, or other mechanisms to agitate the first solution 10. In the embodiment schematically illustrated in FIG. 3A, the mixing system 12 comprises a magnetic stirrer which includes a stir bar 13 comprising a ferromagnetic material and a magnetic driver 14 coupled to the stir bar 13. Upon activation, the magnetic driver 14 generates magnetic forces to spin the stir bar 13 within the first solution 10 for a predetermined period of time. In other embodiments, as schematically illustrated in FIG. 3C (discussed more fully below), the mixing system 12 comprises a mechanical stirrer 15 which is inserted into the first solution 10, activated to agitate the first solution 10 for a predetermined period of time, then removed from the first solution 10.

In certain embodiments, the first temperature is preferably approximately equal to or less than 0 degrees Celsius, more preferably approximately equal to or less than −10 degrees Celsius, still more preferably approximately equal to or less than −25 degrees Celsius, and most preferably approximately equal to or less than −40 degrees Celsius. In certain embodiments in which the first temperature is approximately equal to or less than 0 degrees Celsius, the first solution 10 can be cooled in a first vessel 11 placed in an ice bath 16 comprising a mixture of water and ice, as schematically illustrated in FIG. 3A. In still other embodiments, the first solution 10 can be cooled in a first vessel 11 contained within a refrigerator 17, as schematically illustrated in FIG. 3B. One example of a refrigerator 17 compatible with embodiments of the present invention is an Isotemp General Purpose Lab Refrigerator available from Fisher Scientific International of Hampton, N.H.

In certain embodiments in which the first temperature is approximately equal to or less than −10 degrees Celsius, the first solution 10 can be cooled in a first vessel 11 placed in a glycol bath 18 comprising a mixture of propylene glycol or ethylene glycol and water, typically in approximately equal proportions. In certain embodiments, as schematically illustrated in FIG. 3C, the glycol bath 18 is coupled to a chiller 19 which removes heat from the glycol bath 18 to maintain the desired first temperature. One example of a chiller 19 compatible with embodiments of the present invention is an RTE-140 Low Temperature Bath Circulator from Thermo Neslab of Portsmouth, N.H. In other embodiments in which the first temperature is approximately equal to or less than −25 degrees Celsius, the first solution 10 can be cooled in a first vessel 11 contained within a freezer 22, as schematically illustrated in FIG. 3D. One example of a freezer 22 compatible with embodiments of the present invention is an Isotemp General Purpose Lab Freezer available from Fisher Scientific International of Pittsburgh, Pa.

In certain embodiments in which the first temperature is approximately equal to or less than −40 degrees Celsius, the first solution 10 can be cooled in a first vessel 11 placed in a dry ice bath 23 comprising a mixture of dry ice (CO₂), propylene glycol or ethylene glycol, and water, as schematically illustrated in FIG. 3E. Typically, the dry ice bath 23 comprises equal amounts of propylene glycol or ethylene glycol, and water, and a sufficient amount of dry ice to reduce the temperature of the dry ice bath 23 to the desired level. In certain embodiments, a freezer 22 can be used to reach temperatures equal to or less than −40 degrees Celsius, as schematically illustrated in FIG. 3D. One example of a freezer 22 compatible with embodiments of the present invention is an ULT-80 Ultra Low Temperature Bath Circulator from Thermo Neslab of Portsmouth, N.H. In other embodiments, the first solution 10 can be cooled by bubbling nitrogen vapor 24 from a liquid nitrogen reservoir 25 through the first solution 10, as schematically illustrated in FIG. 3F.

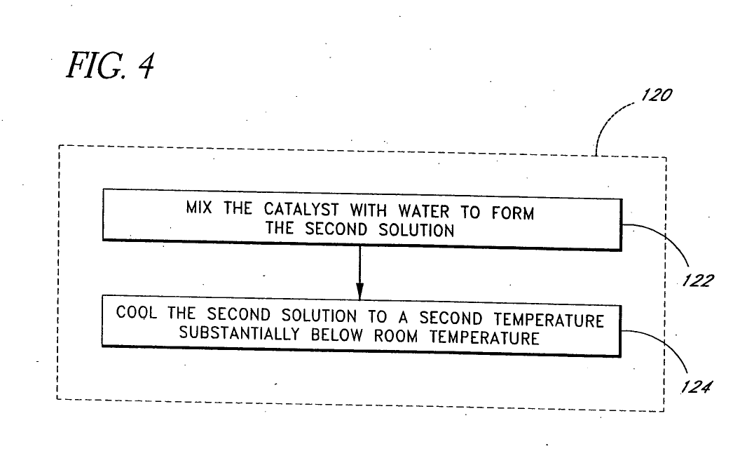

As illustrated in the flow diagram of FIG. 4, in certain embodiments, preparing 120 the second solution 20 comprises an operational block 122 in which the catalyst is mixed with water to form the second solution 20 and an operational block 124 in which the second solution 20 is cooled to a second temperature substantially below room temperature. While FIG. 4 illustrates a particular embodiment in which mixing 122 occurs before cooling 124, in other embodiments one or both of the mixed constituents of the second solution 20 (i.e., the catalyst and the water) are cooled before or while being mixed together.

In certain embodiments, mixing 122 the catalyst with water is achieved by pouring both constituents of the second solution 20 into a second vessel. Similarly to the mixing 112 of the metal alkoxide with the solvent to form the first solution 10, in other embodiments, a stirring system can be used to agitate the second solution 20 to ensure sufficiently homogeneous mixing of the catalyst and water. Examples of stirring systems in accordance with embodiments of the present invention include, but are not limited to, magnetic stirrers, mechanical stirrers, static mixers, or other mechanisms to agitate the second solution 20.

In certain embodiments, the second temperature is preferably approximately equal to or less than 0 degrees Celsius, more preferably approximately equal to or less than −10 degrees Celsius, still more preferably approximately equal to or less than −25 degrees Celsius, and most preferably approximately equal to or less than −40 degrees Celsius. In certain embodiments in which the second temperature is approximately equal to or less than 0 degrees Celsius, the second solution 20 can be cooled in the second vessel placed in an ice bath 16 or contained in a refrigerator 17, as described above in relation to the cooling of the first solution 10. Similarly, in embodiments in which the second temperature is approximately equal to or less than −10 degrees Celsius, a glycol bath 18 and chiller 19 can be used, in embodiments in which the second temperature is approximately equal to or less than −25 degrees Celsius, a freezer 22 can be used, and in embodiments in which the second temperature is approximately equal to or less than −40 degrees Celsius, a dry ice bath 23 or a freezer 22 can be used. In addition, in other embodiments, the second solution 20 can be cooled by bubbling nitrogen vapor 24 from a liquid nitrogen reservoir 25 through the second solution 20.

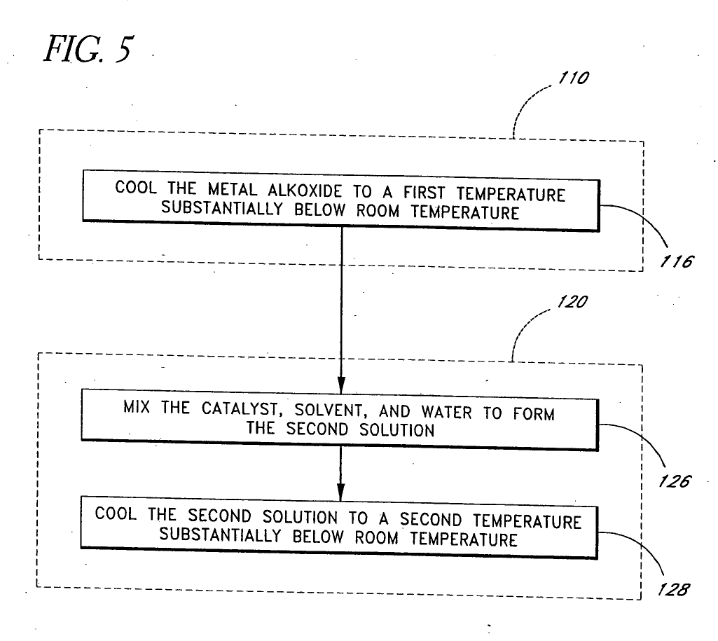

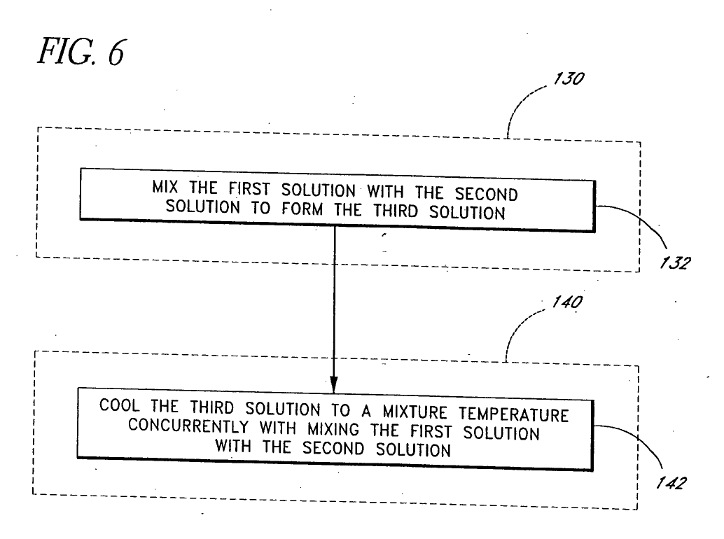

In certain embodiments, the first solution 10 can comprise metal alkoxide and the second solution 20 can comprise the catalyst, solvent, and water. In such an embodiment, as illustrated in the flow diagram of FIG. 5, preparing 110 the first solution 10 comprises cooling the metal alkoxide to a first temperature substantially below room temperature in an operational block 116. In such an embodiment, preparing 120 the second solution 20 comprises mixing the catalyst, solvent, and water to form the second solution 20 in an operational block 126, and cooling the second solution 20 to a second temperature substantially below room temperature in an operational block 128. Embodiments such as that illustrated in FIG. 5 avoid having the water freeze which would inhibit sufficient mixing and further processing of the gel monolith, for example in embodiments in which the second temperature is approximately equal to or less than −25 degrees Celsius. Other embodiments for preparing the first solution 10 and second solution 20 include other procedures for cooling the first solution 10 and second solution 20 without freezing any of the constituents.

As illustrated in the flow diagram of FIG. 6, in certain embodiments, preparing 130 the third solution 30 comprises an operational block 132 in which the first solution 10 is mixed with the second solution 20 to form the third solution 30. In certain embodiments, mixing 132 the first solution 10 and second solution 20 is achieved by pouring both solutions 10, 20 into a third vessel 55. Alternatively in other embodiments, the first solution 10 is maintained at a temperature substantially below room temperature while being transferred to the third vessel 55 via a material measurement system 60.

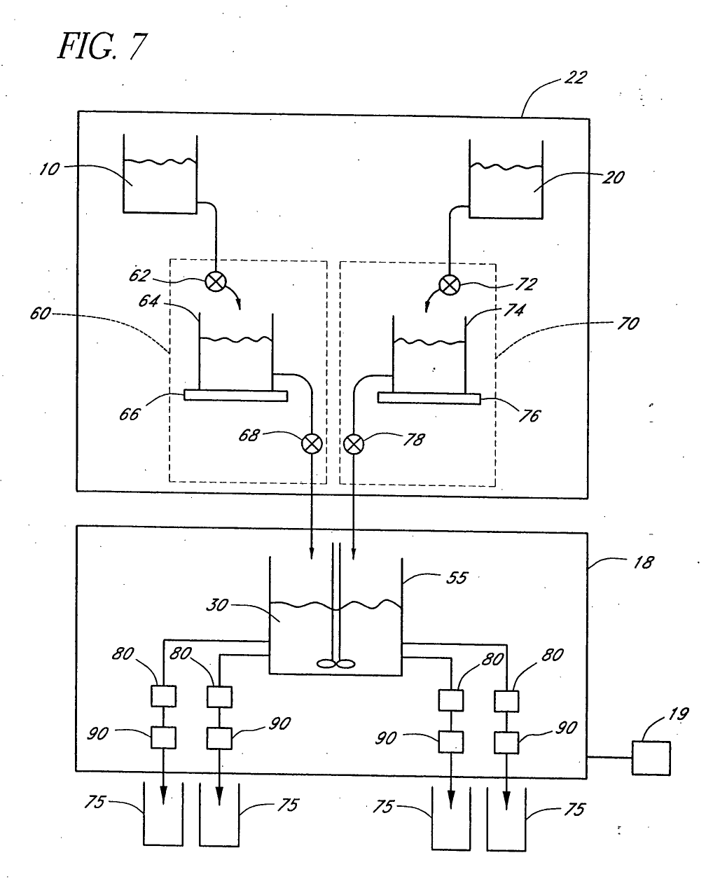

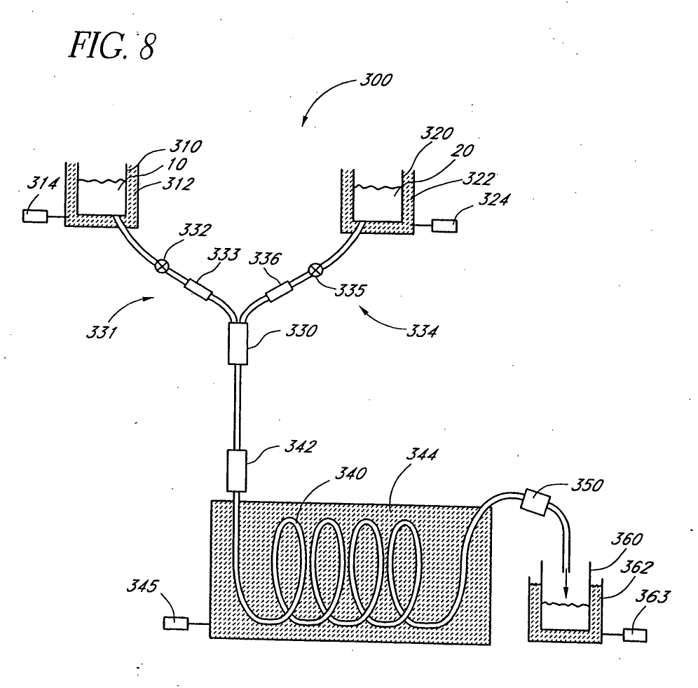

As schematically illustrated in FIG. 7, the material measurement system 60 of certain embodiments comprises an input valve 62, a measuring vessel 64, a scale 66, and an output valve 68. In certain embodiments, the input valve 62 is adjustable and coupled to a proportional-integral-differential (PID) controller (not shown) to control the flow of the first solution 10 into the measuring vessel 64. The scale 66 of certain embodiments is a weight scale which provides a measure of the amount of the first solution 10 in the measuring vessel 64. Alternatively, in other embodiments, the scale 66 measures the total volume of the first solution 10 in the measuring vessel 64. The output valve 68 of certain embodiments is coupled to a solenoid (not shown) which opens and closes the output valve 68 in response to signals. In certain embodiments, the second solution 20 is transferred to the third vessel 55 via a second material measurement system 70. The second material measurement system 70 can be similar to the material measurement system 60 for the first solution 10, i.e., comprising a second input valve 72, a second measuring vessel 74, a second scale 76, and a second output valve 78, as schematically illustrated in FIG. 7. Other embodiments of the material measurement system 60 do not comprise a scale 66 or a second scale 76. Furthermore, in still other embodiments, the first solution 10 and the second solution 20 can be metered directly into the third vessel 55, thereby avoiding the measuring vessels 64, 74.

Similarly to the mixing 112 of the metal alkoxide with the solvent to form the first solution 10, in other embodiments, a stirring system can be used to agitate the third solution 30 to ensure sufficiently homogeneous mixing of the first solution 10 and second solution 20. Examples of stirring systems in accordance with embodiments of the present invention include, but are not limited to, magnetic stirrers, mechanical stirrers, static mixers, or other mechanisms to agitate the third solution 30.

At least one of the first solution 10, second solution 20, and third solution 30 is cooled 140 to achieve a mixture temperature for the third solution 30 which is substantially below room temperature. As illustrated in an operational block 142 of FIG. 6, in certain embodiments, the third solution 30 is cooled 142 to the mixture temperature concurrently with mixing 132 the first solution 10 with the second solution 20. In the embodiment schematically illustrated in FIG. 7, the third vessel 55 is in a glycol bath 18 coupled to a chiller 19 to maintain the third solution 30 at a temperature substantially below room temperature during mixing. While FIG. 6 illustrates a particular embodiment in which mixing 132 occurs concurrently with cooling 142, in other embodiments cooling 140 the third solution 30 occurs after mixing 132, or one or both of the mixed constituents of the third solution 30 (i.e., the first solution 10 or the second solution 20) are cooled before being mixed together.

Once the first solution 10 and the second solution 20 are mixed together, the metal alkoxide of the first solution 10 and the water of the second solution 20 begin to undergo exothermic hydrolysis and polymerization reactions which result in the formation of the gel monolith. The presence of a catalyst, such as HF, increases the reaction rates of these hydrolysis and polymerization reactions, thereby reducing the gelation time. With the temperature of the third solution 30 increasing due to the exothermic reactions, the reaction rates of these reactions increase even further, thereby reducing the gelation time even further. As described above, due to the combination of high catalyst concentrations and increased heat from the exothermic reactions, the hydrolysis and polymerization reaction rates can become too fast (i.e., the gelation time is too short) to allow sufficient processing of the gel monolith resulting from the third solution 30. Therefore, in embodiments of the present invention in which the third solution 30 comprises a catalyst, the third solution 30 is cooled 142 to a mixture temperature substantially below room temperature concurrently with the mixing 132 to reduce the heat available to the hydrolysis and polymerization reactions and to slow down the kinetics of these reactions. At the mixture temperature, the third solution 30 has a longer gelation time as compared to its gelation time at room temperature.

In certain embodiments, the mixture temperature is preferably approximately equal to or less than 0 degrees Celsius, more preferably approximately equal to or less than −10 degrees Celsius, still more preferably approximately equal to or less than −25 degrees Celsius, and most preferably approximately equal to or less than −40 degrees Celsius. In certain other embodiments, the third solution 30 is cooled to a mixture temperature at which the gelation time of the third solution 30 is increased by at least ten times as compared to the gelation time of the third solution 30 at room temperature. In certain embodiments in which the mixture temperature is approximately equal to or less than 0 degrees Celsius, the third solution 30 can be cooled using an ice bath 16 or a refrigerator 17, as described above in relation to the cooling of the first solution 10. Similarly, in embodiments in which the mixture temperature is approximately equal to or less than −10 degrees Celsius, a glycol bath 18 and chiller 19 can be used, in embodiments in which the mixture temperature is approximately equal to or less than −25 degrees Celsius, a freezer 22 can be used, and in embodiments in which the mixture temperature is approximately equal to or less than −40 degrees Celsius, a dry ice bath 23 or a freezer 22 can be used. In addition, in other embodiments, the third solution 30 can be cooled by bubbling nitrogen vapor 24 from a liquid nitrogen reservoir 25 through the third solution 30.

In certain embodiments, the third solution 30 is allowed to gel, thereby forming the gel monolith, as illustrated in the operational block 150 of the flow diagram of FIG. 1. The cooled third solution 30 is poured into a mold 75 in certain embodiments, where the hydrolysis and polymerization reactions are allowed to continue so that the third solution 30 gels into the gel monolith. In certain other embodiments, the third solution 30 is prepared by mixing the first solution 10 and second solution 20, filtering the resultant third solution 30, transferring the third solution 30 into the mold 75, and cooling the third solution 30 in the mold 75 while the third solution 30 continues to gel to form the gel monolith.

In still other embodiments, as schematically illustrated in FIG. 7, the third solution 30 is transferred from the third vessel into a series of molds 75 at approximately 20 degrees Celsius via cooled pumps 80 and cooled filters 90. In certain embodiments, the pumps 80 are either cooled or insulated to prevent the temperatures of the third solution 30 from increasing while flowing to the molds 75. One example of a pump 80 compatible with embodiments of the present invention is Type Number UND1.300TT.18, available from KNF Neuberger, Inc. of Trenton, N.J.

The filters 90 remove particles from the third solution 30 which would degrade the quality of the resultant gel monolith. These particles can be contaminants or can be due to pre-gelling of small amounts of the third solution 30. In certain embodiments, each filter 90 comprises multiple filters, which can be chosen to remove particles within certain size ranges. For example, a filter 90 can comprise a 0.6 μm filter connected in series with a 0.05 μm filter. Filters of other sizes of particles are also compatible with embodiments of the present invention. In certain embodiments, the filters 90 are cooled or insulated to prevent the temperatures of the third solution 30 from increasing while flowing therethrough. Exemplary filters 90 compatible with embodiments of the present invention are available from Millipore Corporation of Bedford, Mass.

FIG. 8 schematically illustrates a mixing station 300 compatible with embodiments of the present invention in which the first solution 10 and second solution 20 are each prepared in a first vessel 310 and second vessel 320, respectively. In the embodiment schematically illustrated in FIG. 8, the first vessel 310 is cooled by a first glycol bath 312 which is maintained at a first temperature by a chiller 314. Similarly, the second vessel 320 is cooled by a second glycol bath 322 which is maintained at a second temperature by a chiller 324. In certain other embodiments, the first temperature and second temperature are approximately equal, and the first solution 10 and second solution 20 are cooled to the same temperature by a single bath. In addition, as described above, other types of baths or cooling procedures to reduce the temperatures of the first solution 10 and second solution 20 are in accordance with embodiments of the present invention.

In certain embodiments, the first vessel 310 is coupled to a static mixer 330 via a first fluid conduit 331 comprising a first valve 332 and a first pump 333, and the second vessel 320 is coupled to the static mixer 330 via a second fluid conduit 334 comprising a second valve 335 and a second pump 336. As schematically illustrated in FIG. 8, the first solution 10 is pumped through the first fluid conduit 331 from the first vessel 310 by the first pump 333 upon opening the first valve 332. Similarly, the second solution 20 is pumped through the second fluid conduit 334 from the second vessel 320 by the second pump 336 upon opening the second valve 335. In certain such embodiments, the mixing station 300 is configured to match the pressure drops along the first fluid conduit 331 and second fluid conduit 334 (e.g., by pressurizing the first vessel 310 and second vessel 320). In certain embodiments, the first fluid conduit 331 and second fluid conduit 334 are either cooled or insulated to prevent the temperatures of either the first solution 10 or second solution 20 from increasing while flowing to the static mixer 330.

Certain embodiments comprise an in-line static mixer 330, as schematically illustrated in FIG. 8, which has various mixing elements to generate vortices as the fluid flows through the static mixer 330, thereby providing an efficient mixing of the fluids flowing therethrough. Exemplary static mixers 330 compatible with embodiments of the present invention are available from Cole-Parmer Instrument Company of Vernon Hills, Ill. In certain embodiments, the static mixer 330 is either cooled or insulated to prevent the temperature of the third solution 30 from increasing while being mixed in the static mixer 330.

In the embodiment schematically illustrated in FIG. 8, the mixing station 300 further comprises a cooling coil 340 coupled to the static mixer 330 via a third pump 342. In certain embodiments, the cooling coil 340 is a thin-walled tube placed in a third glycol bath 344 which is coupled to a third chiller 345. The thin walls of the cooling coil 340 permit heat transfer from the third solution 30 to the third glycol bath 344, thereby achieving a mixture temperature for the third solution 30 substantially below room temperature. In addition, as described above, other types of baths or cooling procedures to reduce the mixture temperature of the third solution 30 are in accordance with embodiments of the present invention.

In the embodiment schematically illustrated in FIG. 8, the mixing station 300 comprise a filter 350 coupled to the cooling coil 340. In certain embodiments, the filter 350 comprises multiple filters, which can be chosen to remove particles within certain size ranges. For example, the filter 350 can comprise a 0.6 μm filter connected in series with a 0.05 μm filter. In certain embodiments, the filter 350 is cooled or insulated to prevent the temperatures of the third solution 30 from increasing while flowing therethrough. Exemplary filters 350 compatible with embodiments of the present invention are available from Millipore Corporation of Bedford, Mass.

In the embodiment schematically illustrated in FIG. 8, the third solution 30 flows through the filter 350 to the mold 360, which is in a fourth glycol bath 362 coupled to a fourth chiller 363. Alternatively in other embodiments, the mold 360 is at approximately room temperature. Once in the mold 360, the third solution 30 is permitted to gel, thereby forming the gel monolith. In addition, as described above, other types of baths or cooling procedures to reduce the temperature of the third solution 30 are in accordance with embodiments of the present invention.

In certain other embodiments, because of the corrosive nature of the constituents of the third solution 30 (e.g., the hydrogen fluoride catalyst), some or all of the components of the mixing station 300 have their internal portions coated with a protective material. Examples of protective materials in accordance with embodiments of the present invention include, but are not limited to, Teflon® available from E.I. DuPont de Nemours & Co. of Wilmington, Del. or Kynar® available from Elf Atochem North America of Philadelphia, Pa.

In certain other embodiments, some or all of the valves, pumps, and chillers are controlled by a control system comprising a microprocessor. In response to user input, the control system can regulate the timing and duration of the flow of the first solution 10, second solution 20, and third solution 30, as well as the temperatures of these solutions.

By preparing the third solution 30 at a mixture temperature substantially below room temperature, embodiments of the present invention allow higher percentages of catalyst in the third solution 30 without having gelation times which inhibit further processing of the gel monolith. For example, the gelation time for a third solution 30 comprising approximately 3.7 mole % of HF at room temperature is on the order of 100 to 200 seconds. Typically, a gelation time greater than approximately 5 minutes is required to pour the third solution 30 into a mold and to permit bubbles to diffuse out of the third solution 30, thereby avoiding difficulties in the processing of the gel monolith. When processing larger quantities of solution (e.g., during production runs), the time required to process the solution can be even longer. However, by preparing the same third solution 30 comprising approximately 3.7 mole % of HF at −14 degrees Celsius, the gelation time is on the order of 10 to 30 minutes. By preparing the third solution 30 at −40 degrees Celsius, the third solution 30 can comprise approximately 10 mole % of HF before the gelation time is shortened to 10 minutes.

As described above, higher percentages of the catalyst result in larger pore sizes in the resultant gel monolith, thereby reducing the capillary stresses generated during drying of the gel monolith. For example, a third solution 30 comprising approximately 3.7 mole % of HF results in a gel monolith with pore sizes of approximately 500 Å, while a third solution 30 comprising approximately 7.4 mole % of HF results in a gel monolith with pore sizes of approximately 1150 Å.

In certain embodiments, the third solution 30 comprises preferably greater than approximately 3 mole % of a catalyst, more preferably greater than 4 mole % of a catalyst, and most preferably greater than 10 mole % of a catalyst. These catalyst concentrations are accompanied in certain embodiments by solvent concentrations in the third solution 30 of approximately 0.5 mole % or less. In certain embodiments, the third solution 30 comprising greater than approximately 3 mole % of the catalyst is cooled to have a gelation time greater than approximately five minutes. In certain other embodiments, the third solution 30 comprising greater than approximately 3 mole % of a catalyst is cooled to have a gelation time greater than one hour. In still other embodiments, the third solution 30 comprising greater than approximately 3 mole % of a catalyst is cooled to have a gelation time greater than two hours.

Monoliths produced using chemical-vapor deposition techniques typically have pore diameter distributions which range from approximately 1000 Å to 2000 Å (i.e., with standard deviations of approximately 500 Å). In certain embodiments, the third solution 30 can result in gel monoliths with pore diameter distributions with mean pore diameters between approximately 400 Å and approximately 1600 Å, but with smaller ranges of diameters than those obtained using chemical-vapor deposition techniques, as described more fully below.

In an exemplary embodiment, a first solution 10 comprising approximately 900 grams of TEOS, approximately 117 grams of TEOG, and approximately 440 grams of ethanol is prepared and stored in a freezer 22 at a temperature of approximately −30 degrees Celsius for approximately 20 hours. A second solution 20 comprising approximately 110 grams of ethanol, approximately 165 grams of water, and approximately 50 grams of a 49% HF (51% water) solution is also prepared and stored in the freezer 22 at a temperature of approximately −30 degrees Celsius for approximately 20 hours. The first solution 10 and the second solution 20 are then mixed together using a magnetic stirrer in a vessel in a glycol bath 18 coupled to a chiller 19 whereby the temperature of the resultant third solution 30 is maintained between approximately −10 degrees Celsius and −15 degrees Celsius. After mixing for a minimum of approximately five minutes, the third solution 30 is pumped into a mold 75 through a filter 80 comprising a 0.6 μm filter and a 0.05 μm filter. The mold 75 is then moved to a flat and safe area at approximately room temperature where the third solution 30 sits and forms a gel monolith. After the third solution 30 forms the gel monolith, ethanol is poured onto the gel monolith to prevent cracking due to the reaction heat generated inside the gel monolith body. All the steps of this exemplary embodiment are performed in a class 1000 or better clean room environment in which the temperature is maintained at approximately 60 degrees Fahrenheit to 70 degrees Fahrenheit and the humidity is between approximately 35% and 55%.

Prior to casting the gel monolith, the mold used for the casting is cleaned in certain embodiments to avoid any materials or particulate matter which could degrade the resultant gel monolith and could create bubbles between the gel monolith and the mold which would be potential stress points for cracking. Such cleaning procedures are also particularly important for embodiments in which a good surface finish of the gel monolith is desired.

Forming Halogen-Doped Solutions

In certain embodiments, it is desirable to use dopants to modify the optical properties of the resultant glass monoliths. For example, the transmittance of a photomask at the wavelengths used for semiconductor photolithography fabrication depends on the dopant concentrations of the photomask. In addition, doping with fluorine can decrease the refractive index of the material, as compared to the refractive index of pure silica.

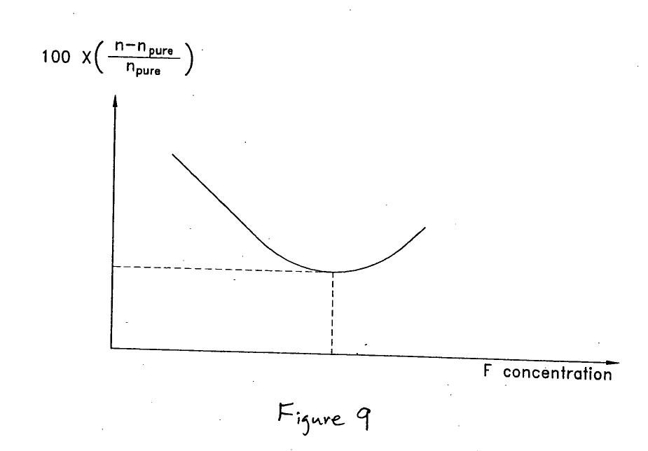

FIG. 9 schematically illustrates the dependence of the refractive index of fluorine-doped silica glass as a function of fluorine concentration for an exemplary system. The refractive index decreases with increasing fluorine concentration, reaching a minimum dependent on the system. In certain systems, the minimum refractive index occurs at approximately 8 wt. % of fluorine. Further increases of the fluorine concentration result in less reduction of the refractive index as compared to pure silica glass. Therefore, to provide reduced-index silica glass, it is desirable to dope silica glass with fluorine to maximize the reduction of the refractive index. Similarly, the transmittance of a fluorine-doped silica glass can be maximized by an optimum fluorine concentration. In certain embodiments, the optimum fluorine concentration for transmittance and the optimum fluorine concentration for minimizing the refractive index are substantially the same, while in other embodiments, they are different.

Various techniques, including standard chemical vapor deposition, have been used previously to introduce fluorine or other elements into silica glass in an attempt to increase the transmittance of the glass at the desired wavelength (e.g., vacuum-ultraviolet region near 157 nanometers). However, the highest fluorine percentages achieved by such processes have been approximately 1.5 wt. % fluorine. For example, U.S. Pat. No. 6,492,072 to Moore et al., U.S. Pat. No. 6,541,168 to Brown et al., and U.S. Pat. No. 6,606,883 to Hrdina et al., each of which is incorporated in its entirety by reference herein, disclose using outside vapor deposition (OVD) to form a soot preform, which is then dehydrated in a furnace at various temperatures and with various atmospheres, which at one point comprises a fluorine-containing gas (e.g., CF₄). The fluorine concentrations achievable by such gas-phase deposition processes are limited due to the volatility of the fluorine-containing compounds.

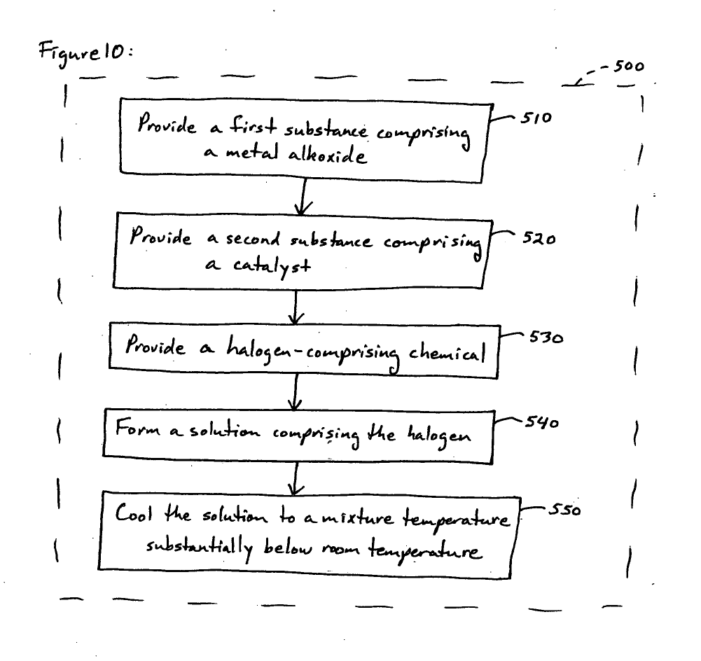

FIG. 10 is a flow diagram of a method 500 of preparing a solution for forming a halogen-doped gel monolith in accordance with embodiments of the present invention. While the flow diagram of FIG. 10 illustrates a particular embodiment with steps in a particular order, other embodiments with different orders of steps are also compatible with the present invention.

In the embodiment described in FIG. 10, in an operational block 510, a first substance is provided, the first solution comprising a metal alkoxide. In an operational block 520, a second substance is provided, the second substance comprising a catalyst. In an operational block 530, a halogen-comprising chemical is provided. In an operational block 540, a solution comprising the halogen is formed, said forming comprising mixing the first substance and the second substance together with the halogen-comprising chemical. In an operational block 550, the solution is cooled to a mixture temperature which is substantially below room temperature. The solution has a significantly longer gelation time at the mixture temperature than at room temperature.

Examples of metal alkoxides compatible with embodiments of the present invention include, but are not limited to, silicon alkoxides (such as tetramethylorthosilicate (TMOS) or tetraethylorthosilicate (TEOS)), aluminum alkoxides, zirconium alkoxides, and titanium alkoxides. In certain embodiments, the first substance comprises more than one metal alkoxide. In certain embodiments, the first substance further comprises a solvent. Examples of solvents include, but are not limited to, alcohols (e.g., ethyl alcohol, methyl alcohol, isopropanol, or other reagent alcohols). The first substance in certain embodiments comprises a plurality of substances in liquid form (e.g., a solution of two or more substances), while in other embodiments, it is a powder.

Examples of catalysts include, but are not limited to, hydrofluoric acid (HF) and ammonia (NH₃). In certain embodiments, the second substance further comprises a solvent, examples of which include, but are not limited to alcohols (e.g., ethyl alcohol, methyl alcohol, isopropanol, or other reagent alcohols). The second substance in certain embodiments comprises a plurality of substances (e.g., a solution of two or more substances), while in other embodiments, it is a single substance.

Examples of halogens include, but are not limited to, fluorine, iodine, and bromine. In certain embodiments, the halogen-comprising chemical includes a fluorine-containing chemical (e.g., triethoxyfluorosilane, trimethoxyfluorosilane, tripropyloxyfluorosilane, HF, LiF, and AlF₃), an iodine-containing chemical (e.g., IBr₃, ICl₃), or a bromine-containing chemical (e.g., BrF₃, BrCl). In addition, using a plurality of dopants is compatible with certain embodiments.

In certain embodiments, the catalyst comprises the halogen-comprising chemical. For example, in embodiments in which the catalyst comprises hydrofluoric acid, the catalyst can also serve as the halogen-comprising chemical to provide fluorine to the gel monolith. In such embodiments, because the second substance already comprises HF, additional halogen-comprising chemical does not have to be added to the first substance, second substance, or the solution. In certain other embodiments, the catalyst comprises a fluorine-containing chemical (e.g., HF), but the halogen-comprising chemical is substantially fluorine-free (e.g.,IBr₃). The resultant glass monolith of such embodiments will be doped with both fluorine and iodine.

In certain embodiments, the first substance comprises the halogen-comprising chemical, in other embodiments, the second substance comprises the halogen-comprising chemical, and in still other embodiments, both the first substance and second substance comprise the halogen-comprising chemical. In still other embodiments, the halogen-comprising chemical is added to the mixed first and second substances.

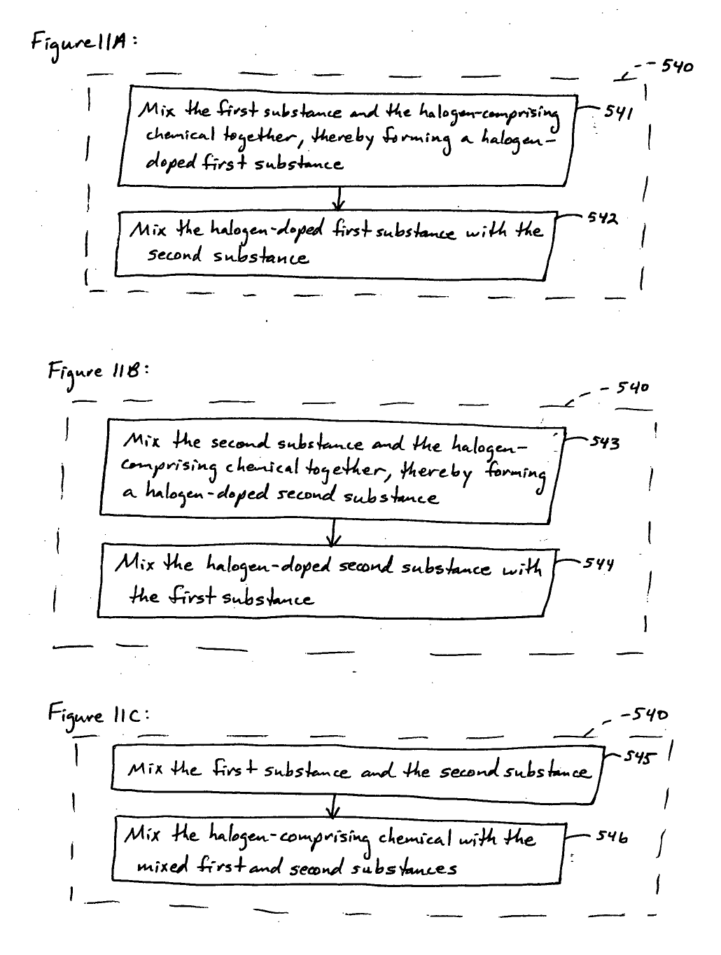

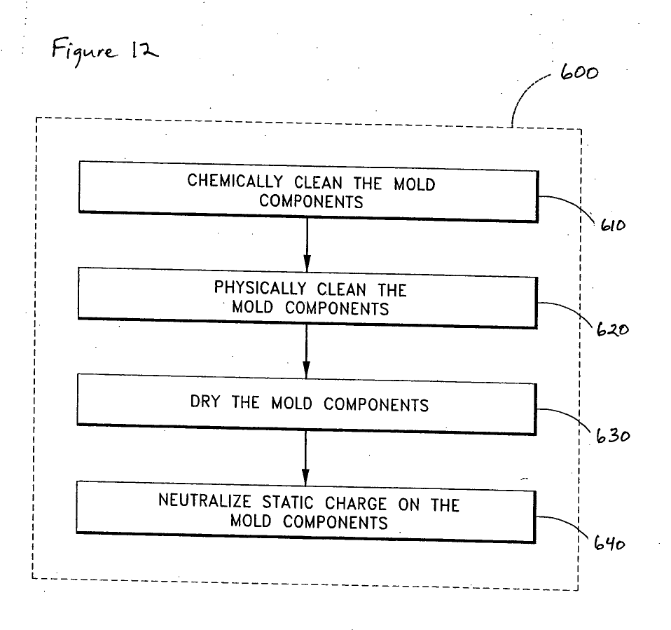

FIGS. 11A-11C are flow diagrams of various embodiments of the operational block 540. In the embodiment described in FIG. 11A, forming the solution comprises mixing the first substance and the halogen-comprising chemical together in an operational block 541, thereby forming a halogen-doped first substance. In such embodiments, the halogen-doped first substance is mixed with the second substance in an operational block 542 to form the solution comprising the halogen.

In the embodiment described in FIG. 11B, forming the solution comprises mixing the second substance and the halogen-comprising chemical together in an operational block 543, thereby forming a halogen-doped second substance. In such embodiments, the halogen-doped second substance is mixed with the first substance in an operational block 544 to form the solution comprising the halogen.

In the embodiment described in FIG. 11C, forming the solution comprises mixing the first substance and second substance in an operational block 545, then mixing the halogen-comprising chemical with the mixed first and second substances in an operational block 546. In certain such embodiments, upon mixing, the first and second substances begin to undergo gelation. If gelation is permitted to proceed prior to the addition of the halogen-comprising chemical, incorporation of the halogen in the gel monolith may be incomplete and the resultant gel monolith may not have the desired halogen concentration. In certain embodiments, the halogen-comprising chemical is mixed with the first and second substances concurrently with mixing the first and second substances together. In other embodiments, the halogen-comprising chemical is mixed with the first and second substances at least 5 minutes prior to completion of gelation of the mixed first and second substances.

While in certain embodiments, the second substance further comprises water, in other embodiments, water is added to the solution such that the solution thereby comprises water and metal alkoxide. The solution can then begin to undergo the hydrolysis and polymerization reactions which form the gel. The presence of the catalyst in the solution accelerates the formation of the gel (i.e., reduces the gelation time of the solution as compared to the gelation time without the catalyst) as described above. In addition, in embodiments in which HF is used as the catalyst, the HF can contribute to the fluorine concentration of the resultant glass monolith.

The solution is cooled to a mixture temperature substantially below room temperature in the operational block 550. In certain embodiments (e.g., in which the halogen-comprising chemical comprises a fluorine-containing alkoxide), the mixture temperature is below zero degrees Celsius. Such mixture temperatures serve to slow the formation of the gel, such that the solution has a significantly longer gelation time at the mixture temperature than at room temperature. The gelation time of the solution is extended by keeping the solution at the predetermined temperature below room temperature. The solution can then be allowed to gel, thereby forming a halogen-doped gel monolith.

In certain embodiments, only the solution is cooled to achieve the mixture temperature. In other embodiments, the solution is cooled by cooling the first substance prior to mixing the first and second substances together. In still other embodiments, the solution is cooled by cooling the second substance prior to mixing the first and second substances together. In still other embodiments, the solution is cooled by cooling the halogen-comprising chemical.

In this way, in certain embodiments, achieving a reduced mixture temperature makes it possible to increase the catalyst concentration in the solution while reducing the problematic effects associated with higher catalyst concentrations. Similarly, in other embodiments in which the halogen-comprising chemical speeds up the gelation reaction, achieving a reduced mixture temperature makes it possible to increase the halogen concentration in the solution while avoiding the problems of premature gelation. Furthermore, in certain embodiments utilizing a halogen alkoxide as the halogen-comprising chemical, the reduced mixture temperature affects the gelation rates of the metal alkoxide and the halogen alkoxide, so that the gelation rates are more closely matched to facilitate homogeneous incorporation of the halogen in the resultant gel monolith.

In certain embodiments, the solution preferably comprises at least 1 mole %, more preferably at least 4 mole %, and most preferably at least 8 mole % of the halogen-containing chemical. Such embodiments include those in which the halogen-containing chemical comprises a fluorine-containing chemical. In certain embodiments for forming a fluorine-doped silica glass using a fluorine-containing alkoxide, the solution further comprises hydrogen fluoride (HF) to impede decomposition of the fluorine-containing alkoxide. For example, triethoxyfluorosilane (F—Si(OEt)₃) can decompose in the following reactions: F—Si(OEt)₃+H₂O HF+Si(OEt)₃OH or F—Si(OEt)₃+ethanol HF+TEOS. The inclusion of HF to the solution impedes this decomposition reaction during gelation. This utility of HF is in addition to its utility as a catalyst for the hydrolysis and polymerization reactions during gelation. As described above for embodiments in which HF is included in the solution as a catalyst, reducing the mixture temperature is helpful in embodiments in which HF is included in the solution to impede the decomposition reaction.

Casting a Gel Monolith

Prior to casting the gel monolith, the mold used for the casting is cleaned in certain embodiments to avoid any materials or particluate matter which could degrade the resultant gel monolith and could create bubbles between the gel monolith and the mold which would be potential stress points for cracking. Such cleaning procedures are also particularly important for embodiments in which a good surface finish of the gel monolith is desired.

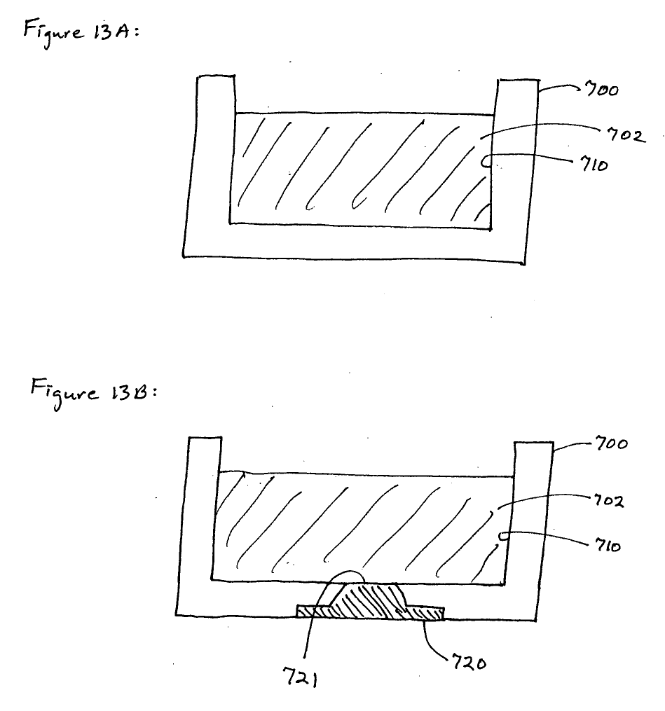

FIG. 12 is a flowchart of a procedure 600 for preparing components of a mold for casting in accordance with embodiments of the present invention. In certain embodiments, the procedure 600 is performed in a Class 1000 (or lower) clean room to reduce the possibility of particulate contamination of the mold prior to casting the gel monolith. In an operational block 610, the components of the mold are chemically cleaned. In an operational block 620, the components of the mold are physically cleaned. In an operational block 630, the components of the mold are dried. In an operational block 640, the components of the mold have any static charge neutralized.

In certain embodiments of the operational block 610, chemically cleaning the mold components comprises soaking the components in a HF solution and rinsing the components with deionized water. In certain such embodiments, a cleaning vessel is provided and visually inspected to ensure that it is free of residue such as dried gel, particles, dust, etc. The cleaning vessel is then filled to a desired level with a cleaning solution comprising deionized water and hydrofluoric acid (HF). In certain embodiments, the HF:H₂O ratio is approximately 1:10. The mold components are then soaked in the cleaning solution for at least approximately 8 hours to remove residual material from the surfaces of the mold components. The mold components are then soaked in a first rinsing vessel containing deionized water for approximately 30 minutes to remove HF which has adhered to the surfaces of the mold components and are then soaked in a second rinsing vessel containing deionized water for approximately 5 minutes. The mold is then filled briefly with deionized water which is then dumped out.

In certain embodiments of the operational block 620, physically cleaning the mold components comprises ultrasonically cleaning the mold components. Certain mold components are filled with deionized water and placed in an ultrasonic cleaner for approximately 30 minutes, and are then emptied. A final rinse with deionized water is then performed.

In certain embodiments of the operational block 630, drying the mold components comprises allowing water to evaporate from the surfaces of the mold components. In certain embodiments of the operational block 640, neutralizing the static charge on the mold components comprises exposing the mold components to an anti-static air flow from a filtered air gun for approximately 10 to 15 seconds. A static meter can be used to ensure that the mold components are no longer statically charged. In addition, a particle counter can be utilized to detect particles within the mold. After the procedure 600, non-static, lint-free material can be used to completely cover the cleaned mold components until they are used for casting. Other embodiments of the procedure 600 for preparing mold components for casting are compatible with embodiments of the present invention.

The shape of the mold into which the solution is placed determines the shape of the resulting wet gel monolith upon gelation. For example, for embodiments in which a generally flat wet gel monolith is desired (e.g., for making a photomask for semiconductor photolithography fabrication), the mold can be a relatively shallow container. For other embodiments, the mold can be designed to have a shape to produce a wet gel monolith having the desired shape. In certain embodiments, the mold comprises multiple components. Certain such multiple-component molds are useful for the casting of multiple-component gel monoliths. In other embodiments, the multiple-component mold can be assembled and disassembled to facilitate removal of the gel monolith or to facilitate cleaning of the mold. Examples of molds with multiple components in the context of sol-gel-derived optical fiber preforms are disclosed in co-pending U.S. patent application Ser. No. 10/062,613, filed Feb. 1, 2002, U.S. patent application Ser. No. 10/062,748, filed Feb. 1, 2002, U.S. patent application Ser. No. 10/062,746, filed Feb. 1, 2002, and U.S. patent application Ser. No. 10/215,162, filed Aug. 7, 2002, each of which is incorporated in its entirety by reference herein.

FIG. 13A schematically illustrates a mold 700 for forming a gel monolith 702. The mold 700 comprises a hydrophobic surface 710 which contacts at least a portion of the gel monolith 702. In certain embodiments, the hydrophobic surface 710 comprises polytetrafluoroethylene (PTFE) (e.g., Teflon®), while in other embodiments, the hydrophobic surface 710 comprises polymethylpentene (PMP), polystyrene (PS), or other hydrophobic materials. In addition, the hydrophobic surface 710 in certain embodiments has a good surface finish (i.e., it is polished and sufficiently defect-free) to provide resultant glass surfaces which conform to the desired specifications. In addition, corner regions 712 of the hydrophobic surface 710 of certain embodiments have a sufficiently large radius of curvature so as to avoid stress-generating corners of the gel monolith. Certain embodiments can utilize a tapered hydrophobic surface 710 to facilitate removal of the gel monolith 702 from the mold 700.

The mold 700 can be fabricated entirely from these materials, thereby providing the hydrophobic surface 710 of such embodiments. Alternatively, the mold 700 can comprise other materials which have a coating of a hydrophobic material (e.g., quartz coated with dichlorodimethylsilane (DCDMS), PTFE, PMP, or PS) on one or more surfaces, thereby forming the hydrophobic surface 710. In certain such embodiments, the mold 700 accompanies the gel monolith 702 through additional processing steps, so the materials comprising the mold 700 are able to withstand the various temperatures, pressures, and exposure to various corrosive compounds (e.g., HF, TEOS, Ge) to which the mold 700 is subjected during the formation of the gel monolith 702. The mold 700 of certain embodiments comprises one or more components which are removably coupled to one another so as to facilitate cleaning of the mold 700 and removal of the gel monolith 702 from the mold 700.

In certain embodiments, the mold 700 can comprise a plug 720, as schematically illustrated in FIG. 13B. When the mold 700 is filled with solution, the plug 720 keeps the solution within the mold 700. The plug 720 has a hydrophobic surface 721 which contacts the gel monolith 702 during gelation. Once the solution has gelled, the plug 720 can be removed, thereby opening a conduit through which liquid from the pores of the gel monolith 702 can flow. Such embodiments facilitate removal of liquid from the pores of the gel monolith 702 during drying while the gel monolith 702 remains in the mold 700.

Drying the Gel Monolith

The embodiments disclosed herein form silica-based gel monoliths which are virtually free of cracks. However, the methods and structures disclosed herein also have application to the formation of gel monoliths generally, including other oxide-based gel monoliths.

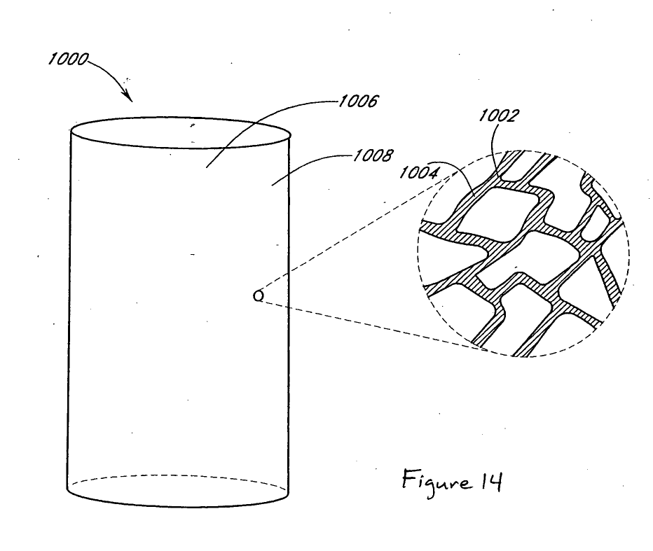

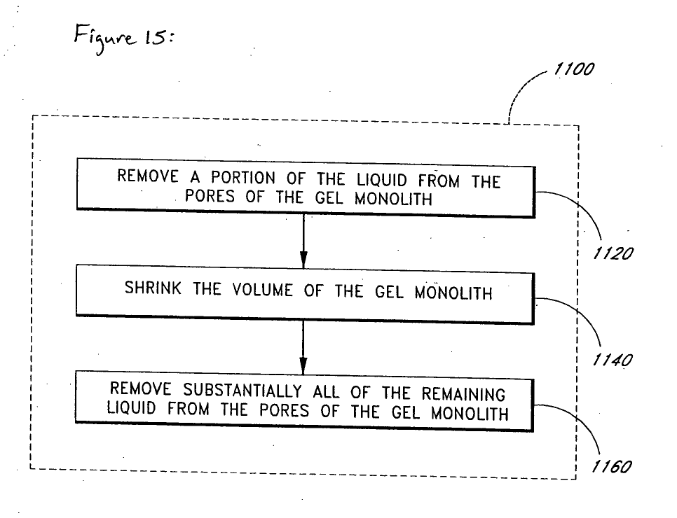

During gelation, the components of the sol undergo hydrolysis and polymerization, resulting in a wet porous gel monolith 1000. As schematically illustrated in FIG. 14, the gel monolith 1000 comprises pores 1002 filled with liquid 1004, an inner region 1006, and an outer region 1008. During the drying of the gel monolith 1000, the gel monolith 1000 shrinks in size, and capillary forces in the gel pores 1002 arise as the amount of liquid 1004 in the gel monolith 1000 is reduced. If the drying of the gel monolith 1000 progresses too quickly in one region of the gel monolith as compared to another region, then inhomogeneities in the capillary forces create stresses in the gel monolith 1000, thereby causing cracks. If the drying of the gel monolith 1000 progresses too slowly, then the fabrication process takes longer than is economically desirable. In embodiments of the present invention, the drying rate of the gel monolith 1000 is controlled to avoid cracking and to provide economically rapid drying without generating large inhomogeneities in the capillary forces during the drying of the gel monolith 1000.

The wet porous gel monolith 1000 of certain embodiments is formed, as described above, by forming a liquid sol by mixing together organo-metallic compounds, such as metal alkoxides, with solvents and catalysts in predetermined proportions and at predetermined temperatures. Suitable metal alkoxide materials include, but are not limited to, TEOS, TEOG, and TMOS. Solvents compatible with the present invention include, but are not limited to, ethanol and other alcohols, and suitable catalysts include, but are not limited to, HCl and HF. Alternatively, the liquid sol is prepared by mixing together inorganic metal salts and water, which form a colloidal dispersion.

The formation of the wet porous gel monolith 1000 of certain embodiments also comprises stirring and pouring the liquid sol into a mold. Colloidal silica-based particles are formed by hydrolysis and polymerization reactions, with the colloidal particles linking together, thereby forming the wet porous silica gel monolith 1000 with pores 1002 filled with liquid 1004.

The microstructure (e.g., pore diameter, surface area, volume, and distribution) of the resulting porous gel monolith 1000 significantly affects the ability of the porous gel monolith 1000 to withstand the capillary forces during the drying process and the ability to subsequently introduce desired dopants or additives to the porous gel monolith 1000 to tailor its properties. For example, as described above, the tendency for cracking of gel monoliths may be reduced by tailoring the gel microstructure so as to produce gel monoliths with larger pore diameters. This microstructure is dependent in part on the relative concentrations of the solvents and the catalysts as described above, and can be varied within a wide range by judicious selection of process parameters. In certain embodiments, drying control chemical additives (“DCCA”) are added to the sol to control its hydrolysis and polymerization rates so as to tailor the pore diameters and distributions.

The time required for formation of the wet porous gel monolith 1000 is dependent on the sol composition, temperature, and the type of catalyst used. In certain embodiments, after formation of the wet porous gel monolith 1000, the pore liquid 1004 may be replaced by a second liquid by removing the gel monolith 1000 from the mold and submerging it in the second liquid while at elevated temperatures (e.g., approximately 60 degrees Celsius to approximately 70 degrees Celsius). After such a procedure, the liquid 1004 within the pores 1002 of the gel monolith 1000 comprises primarily the second liquid. In certain embodiments, the second liquid comprises primarily ethanol, while in other embodiments, the second liquid comprises other alcohols or water. Embodiments utilizing a second liquid comprising an alcohol to replace the pore liquid 1004 comprising water can help subsequent drying, because the diffusion rate of liquid through the pores can be increased and the capillary forces can be reduced.

FIG. 15 is a flow diagram of a method 1100 of processing a gel monolith 1000 in accordance with embodiments of the present invention. The gel monolith comprises pores 1002 filled with liquid 1004, an inner region 1006, and an outer region 1008, an embodiment of which is schematically illustrated in FIG. 14. In certain embodiments, the method 1100 results in a dried xerogel monolith, which is a gel monolith which was not dried under supercritical conditions. While the flow diagram of FIG. 15 illustrates a particular embodiment with steps in a particular order, other embodiments with different orders of steps are also compatible with the present invention.

In certain embodiments, the method 1100 is performed with the gel monolith 1000 in a drying oven which allows the temperature applied to the gel monolith 1000 to be controllably adjusted, resulting in a temporal temperature profile. Examples of heating technologies for drying ovens compatible with embodiments of the present invention include, but are not limited to, resistive heating, microwave heating, and infrared lamp heating.

In certain embodiments, the gel monolith 1000 is removed from the mold prior to being placed in the drying oven, while in other embodiments, the gel monolith 1000 and mold are placed in the drying oven together. The gel monolith 1000 and mold can be inverted upon being placed in the drying oven in certain embodiments, to facilitate handling of the gel monolith 1000 and removal of liquid 1004 from the pores 1002.

In the embodiment diagrammed in FIG. 15, in an operational block 1120, a portion of the liquid 1004 is removed from the pores 1002 of the gel monolith 1000 while both the inner region 1006 and the outer region 1008 of the gel monolith 1000 remain wet. In an operational block 1140, the volume of the gel monolith 1000 shrinks during the removing of the portion of the liquid 1004, with the gel monolith 1000 becoming correspondingly more dense. In an operational block 1160, substantially all of the remaining liquid 1004 is subsequently removed from the pores 1002 of the gel monolith 1000. As is described more fully below, removing substantially all of the remaining liquid 1004 comprises modulating a temperature gradient between the outer region 1008 and the inner region 1006 of the gel monolith 1000.

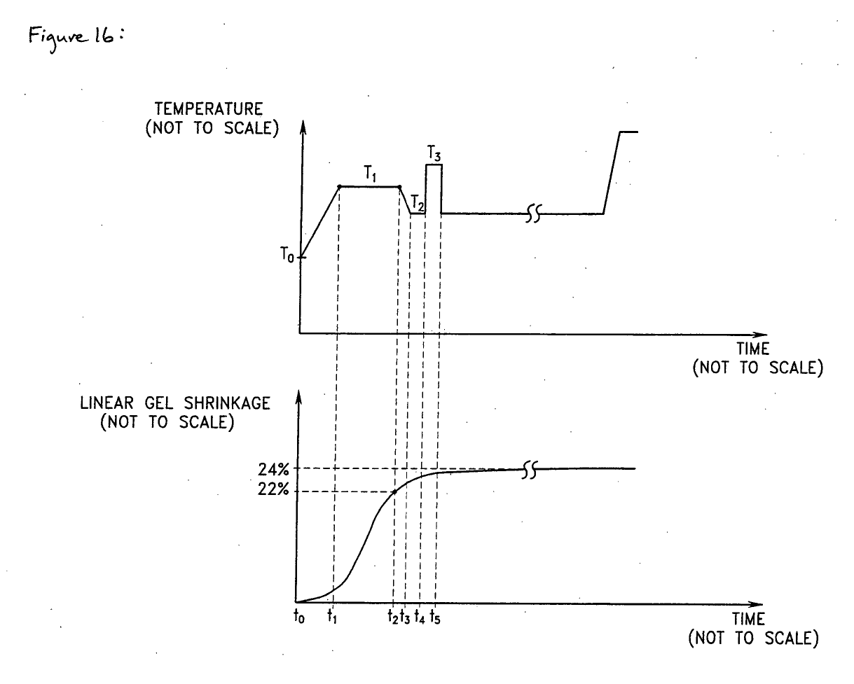

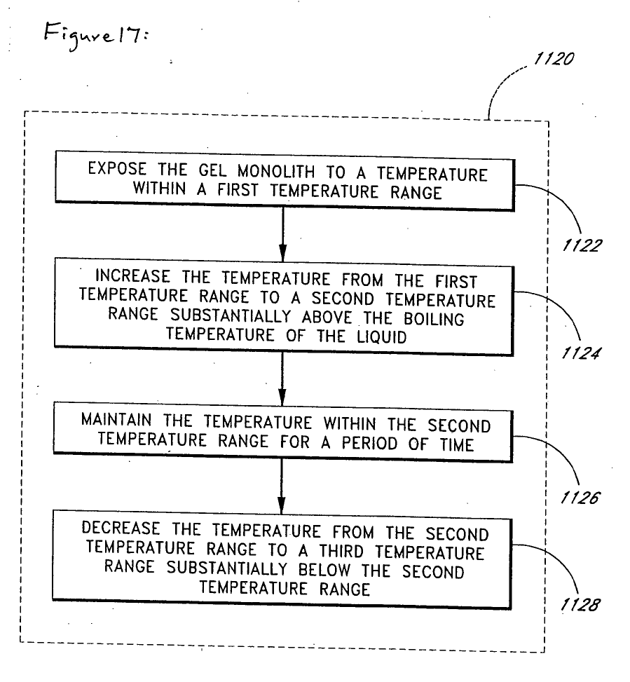

FIG. 16 schematically illustrates a temporal temperature profile compatible with embodiments of the present invention. FIG. 17 is a flow diagram of an embodiment of the operational block 1120 in which a portion of the liquid 1004 is removed from the pores 1002 of the gel monolith 1000. In an operational block 1122, the gel monolith 1000 is exposed to a temperature within a first temperature range. In an operational block 1124, the temperature is increased from the first temperature range to a second temperature range substantially above the boiling temperature of the liquid 1004. In an operational block 1126, the temperature is maintained within the second temperature range for a period of time. In an operational block 1128, the temperature is decreased from the second temperature range to a third temperature range substantially below the second temperature range.

Exposing the wet porous gel monolith 1000 to elevated temperatures in the operational block 1120 increases the rate of evaporation Θₑᵥₐₚ of liquid 1004 from the gel monolith 1000, and reduces the overall time required to dry the gel monolith 1000. In addition, the microstructure of the gel monolith 1000 is dependent on the temporal temperature profile used to remove the liquid 1004 in the operational block 1120. In certain embodiments, removal of the portion of the liquid 1004 in the operational block 1120 results in the gel monolith 1000 having pores 1002 with a pore diameter distribution with an average pore diameter between approximately 200 and approximately 1500 Angstroms, while in certain other embodiments, the average pore diameter is between approximately 400 and approximately 1500 Angstroms, and in still other embodiments, the average pore diameter is between approximately 1000 and approximately 1500 Angstroms.

In certain embodiments, such as that schematically illustrated in FIG. 16, the gel monolith 1000 is exposed to a temperature T₀ at time t₀ in the operational block 1122. The temperature T₀ is in a first temperature range which in certain embodiments is between approximately 0 degrees Celsius and approximately 75 degrees Celsius, in other embodiments is between approximately 0 degrees Celsius and approximately 35 degrees Celsius, and in still other embodiments is between approximately 18 degrees Celsius and approximately 35 degrees Celsius. In certain embodiments, as described above, the sol is prepared at a reduced mixing temperature, and gelation of the sol also occurs at a reduced temperature. In such embodiments, the first temperature range can be dependent on the temperature at which gelation of the gel monolith 1000 occurs. However, in other embodiments, the gel monolith 1000 is allowed to warm during or after gelation, and the drying of the gel monolith 1000 begins at a temperature T₀ which is approximately room temperature (e.g., approximately +18 degrees Celsius to +35 degrees Celsius).

In certain embodiments, the temperature is increased in the operational block 1124 from T₀ to an elevated temperature T₁, at time t₁, as schematically illustrated in FIG. 16. The temperature T₁ is in a second temperature range which in certain embodiments is below approximately 20 degrees Celsius above the boiling temperature of the liquid 1004, in other embodiments is between approximately 3 degrees Celsius and approximately 15 degrees Celsius above the boiling temperature of the liquid 1004, and in still other embodiments is between approximately 5 degrees Celsius and approximately 10 degrees Celsius above the boiling temperature of the liquid 1004. In embodiments in which the liquid 1004 comprises primarily ethanol, the boiling temperature of the liquid 1004 is approximately 78 degrees Celsius.

In certain embodiments, the temperature T₁ is selected based on the overall compressive and tensile stresses on the gel monolith 1000. As T₁ increases, at some temperature, the overall tensile forces within the gel monolith 1000 will exceed the compressive forces, thereby cracking the gel monolith 1000. Because ceramics maintain integrity under compression, T₁ of certain embodiments is selected to keep compressive forces on the gel monolith 1000 greater than tensile forces.

Increasing the temperature from the first temperature range to the second temperature range in the operational block 1124 is performed in certain embodiments at a rate between approximately 0.01 degrees Celsius and approximately 10 degrees Celsius per hour. Alternatively, in other embodiments, increasing the temperature is performed at a rate between approximately 0.01 degrees Celsius and approximately 1.5 degrees Celsius per hour. In still other embodiments, increasing the temperature is performed at a rate approximately equal to 0.042 degrees Celsius per hour. While FIG. 16 shows the rate of temperature increase between times t₀ and t₁ to be generally linear, other embodiments compatible with the present invention can use a nonlinear temperature increase, or can include interim decreases of the temperature.

In certain embodiments, as the temperature approaches the boiling temperature of the liquid 1004, the temperature is increased at a slower ramp rate, thereby reducing the vapor pressure (i.e., tensile force) generated by the evaporating liquid 1004. After a period of time at the slower ramp rate, the ramp rate can be increased until a predetermined temperature is reached. In certain embodiments, this transition from the slower ramp rate to an increased ramp rate occurs at approximately 86.5 degrees Celsius. In certain other embodiments, this transition from the slower ramp rate to an increased ramp rate occurs once a predetermined portion of the liquid 1004 is expelled from the pores 1002 and the gel monolith 1000 approaches its final dimensions (i.e., once the tensile forces due to vapor pressures have a reduced importance.

In the operational block 1126, the temperature of the gel monolith 1000 is maintained within the second temperature range for a period of time. In certain embodiments, the period of time is between approximately 1 hour and approximately 48 hours. In other embodiments, the period of time is between approximately 5 hours and approximately 15 hours. In still other embodiments, the period of time is between approximately 7 hours and approximately 10 hours. While FIG. 16 shows the temperature to be generally constant during the time period (t₂-t₁) between times t₁ and t₂, other embodiments compatible with the present invention can vary the temperature T₁ during the period of time while staying in the second temperature range. As is described more fully below, various methods of monitoring the removal of the portion of the liquid 1004 from the gel monolith 1000 can be used in embodiments of the present invention to determine the period of time and when to initiate removing substantially all of the remaining liquid 1004 in the operational block 1160.

In certain embodiments, in the operational block 1128, the temperature is decreased from the second temperature range to a third temperature range substantially below the second temperature range at a rate between approximately 1 degree Celsius and approximately 10 degrees Celsius per hour. In other embodiments, the temperature is decreased by stepping down the set point temperature of the oven approximately instantaneously from a temperature in the second temperature range to a lower temperature in the third temperature range and allowing the gel monolith 1000 to re-equilibrize at the lower temperature.

In certain embodiments, the third temperature range is between approximately 10 degrees Celsius below and approximately 10 degrees Celsius above the boiling temperature of the liquid 1004. In other embodiments, the third temperature range is between approximately 5 degrees Celsius below and approximately 5 degrees Celsius above the boiling temperature of the liquid 1004. In still other embodiments, the third temperature range is between approximately the boiling temperature of the liquid and approximately 2 degrees Celsius above the boiling temperature of the liquid 1004. While FIG. 16 shows the rate of temperature decrease between times t₂ and t₃ to be generally linear, other embodiments compatible with the present invention can use a nonlinear temperature decrease, or can include interim increases of the temperature.

In certain embodiments in which the gel monolith 1000 is generally cylindrical, the top and bottom portions of the gel monolith 1000 have larger surface areas than do the sides of the gel monolith 1000. Because the evaporation rate is proportional to the surface area, in such embodiments, the top and bottom portions can dry faster and hence shrink more than the sides of the gel monolith 1000. In certain such embodiments, the temperature can be reduced for a period of time so that the liquid 1004 can diffuse to the drier top and bottom portions of the gel monolith 1000, thereby reducing the overall stresses on the gel monolith 1000 by evening out the distribution of liquid 1004 throughout the gel monolith 1000.

Removing the liquid 1004 in the operational block 1120 results in the shrinkage or decrease of the volume of the wet porous gel monolith 1000 in the operational block 1140. The various parameters of this removal of the liquid 1004 (e.g., first temperature range, second temperature range, third temperature range, temperature increase rate, temperature decrease rate, and period of time in the second temperature range) are selected to provide a controlled drying rate of the gel monolith 1000 in the operational block 1120 which is economically rapid but avoids cracking.

The dimensional shrinking of the wet porous gel monolith 1000 in the operational block 1140 is closely correlated with the amount of liquid 1004 removed from the gel monolith 1000 in the operational block 1120. In addition, since it is only the mass of a portion of the pore liquid 1004 which is removed, the mass of the gel monolith 1000 itself remains substantially constant throughout the liquid removal of the operational block 1120. Therefore, the density of the gel monolith 1000 increases while the volume of the gel monolith 1000 shrinks during the removal of the portion of the liquid 1004.

The dimensional or linear gel shrinkage provides a measure of the increasing density of the gel monolith 1000 in the operational block 1140. For example, a linear gel shrinkage of a dimension of 10% (i.e., the dimension is 90% of its original size) corresponds to an increase in the density of the gel monolith 1000 of approximately 37%. In the embodiment illustrated in FIG. 16, beginning from a linear gel shrinkage defined to be 0% at time t₀, the gel monolith 1000 shrinks by some amount during the period of increasing temperature between times t₀ and t₁. The shrinkage of the wet porous gel monolith 1000 then continues as the gel monolith 1000 is held at the temperature T₁ in the second temperature range for a period of time (t₂-t₁) between t₁ and t₂. During the period of time (t₂-t₁) between t₂ and t₃, additional shrinkage of the wet porous gel monolith 1000 can occur, as schematically illustrated in FIG. 16.

As liquid 1004 is removed from the pores 1002 of the gel monolith 1000, the gel monolith 1000 shrinks in size yet remains wet, until the density of the gel monolith 1000 reaches its critical gel density ρ_{crit}, past which there is little or no shrinkage due to removal of liquid 1004. Further removal of liquid 1004 from regions of the gel monolith 1000 which have reached the critical gel density ρ_{crit} results in the drying of those regions. The actual critical gel density ρ_{crit} for a particular gel monolith 1000 is a function of various factors, including, but not limited to its chemical composition, catalysts, and the temporal temperature profile used during the removal of liquid 1004. In certain embodiments, as illustrated in FIG. 16, the critical gel density ρ_{crit} corresponds to a gel monolith linear shrinkage of approximately 24%, which corresponds to a pure silica gel monolith 1000. In other embodiments in which the gel monolith 1000 is Ge-doped, the critical gel density ρ_{crit} can correspond to a gel monolith linear shrinkage of approximately 30%.

In the embodiment schematically illustrated in FIG. 16, the temperature is reduced between times t₂ and t₃, until reaching T₂ in the third temperature range. In certain embodiments, this reduction of the temperature in the operational block 1128 is performed when the gel monolith 1000 has reached a selected gel density which is close to, but less than the critical gel density ρ_{crit}. The selected gel density corresponding to time t₂, for the embodiment illustrated in FIG. 16, is approximately 22%. The selected gel density for a particular gel monolith 1000 is a function of various factors including, but not limited to, its chemical composition, catalysts, geometry (e.g., surface area to volume ratio), and the temporal temperature profile used to remove the portion of the liquid 1004 in the operational block 1120.

Besides triggering the decrease of the temperature of the operational block 1128, the selected gel density in certain embodiments is used to initiate the operational block 1160 in which substantially all of the remaining liquid 1004 is removed from the pores 1002 of the gel monolith 1000. In embodiments in which the selected gel density is less than the critical gel density ρ_{crit}, subsequently removing substantially all of the remaining liquid 1004 from the pores 1002 of the gel monolith 1000 is initiated before the wet porous gel monolith 1000 has densified to substantially its critical gel density ρ_{crit}.

In certain embodiments, subsequently removing substantially all of the remaining liquid 1004 from the pores 1002 of the gel monolith 1000 is initiated when the linear shrinkage of the gel monolith 1000 is between approximately 15% and approximately 35%. In certain other embodiments, subsequently removing substantially all of the remaining liquid 1004 from the pores 1002 of the gel monolith 1000 is initiated when the linear shrinkage of the gel monolith 1000 is between approximately 20% and approximately 30%. In still other embodiments, subsequently removing substantially all of the remaining liquid 1004 from the pores 1002 of the gel monolith 1000 is initiated when the linear shrinkage of the gel monolith 1000 is between approximately 22% and approximately 27%.

In alternative embodiments, rather than measuring the gel density by continually monitoring the linear shrinkage of the gel monolith 1000 to detect the selected gel density, the weight of the portion of the liquid 1004 removed from the pores 1002 of the gel monolith 1000 is monitored. In such embodiments, the amount of liquid 1004 removed from the gel monolith 1000 is used to initiate subsequently removing substantially all of the remaining liquid 1004 from the pores 1002 of the gel monolith 1000.

In certain embodiments, the weight of the removed liquid 1004 is monitored by collecting the evaporated liquid 1004 from the oven, re-condensing the liquid 1004, and weighing the resultant condensate. The evaporated liquid 1004 can be collected via a piping system which provides a conduit for heated vapor from the oven to reach a container on a weight scale. Since the atmosphere in the oven is saturated with vapor from the liquid 1004, upon entering the piping system and the container, the vapor cools, re-condenses, and flows into the container to be weighed. In certain embodiments, the piping system and the container are at approximately room temperature, while in other embodiments, a cooling system (e.g., a condensing unit) is used to cool the piping system and the container to a temperature below room temperature.

After first empirically determining the weight of the collected condensate corresponding to the selected gel density for a gel monolith 1000 of a particular geometry and composition, the weight of the collected condensate provides a measure of the amount of liquid removed from the gel monolith 1000 and the resultant gel density. Expressed as a percentage of the weight of the initial wet porous gel monolith 1000, in certain embodiments, the weight of the removed liquid 1004 which initiates removing substantially all of the remaining liquid 1004 is between approximately 40% and 65%. In other embodiments, the weight of the removed liquid 1004 which initiates removing substantially all of the remaining liquid 1004 is between approximately 40% and 50%. In still other embodiments, the weight of the removed liquid 1004 which initiates removing substantially all of the remaining liquid 1004 is between approximately 44% and 50%.

In addition to monitoring the linear shrinkage of the gel monolith 1000 or the condensate weight, in certain other embodiments, visual examination of the gel monolith 1000 can be used to initiate subsequently removing substantially all of the remaining liquid 1004 from the pores 1002 of the gel monolith 1000. In such embodiments, the wet porous gel monolith 1000 has a clear, slightly bluish appearance from the time to at which the temperature begins to be increased, to the time at which the gel monolith 1000 reaches its critical gel density ρ_{crit}. This appearance of the gel monolith 1000 is indicative of a homogeneous gel monolith 1000 with pore diameters in the range of approximately 200 Angstroms to approximately 1500 Angstroms.

In certain such embodiments, a visual imaging system can be used to monitor the visual appearance of the gel monolith 1000. For example, a digital camera and a microprocessor can determine the height of the gel monolith 1000 to within approximately 1 mm, and can monitor the gel monolith 1000 for the formation of white, opaque features larger than approximately 1 mm. The visual imaging system can be coupled to the control system of the oven so that the temperature of the gel monolith 1000 is controlled in response to its size and visual appearance. Other visual imaging systems are compatible with embodiments of the present invention.

Continual exposure to temperatures in the second temperature range after reaching the critical gel density ρ_{crit} of the gel monolith 1000 causes the outer region 1008 of the gel monolith 1000 to dry out more quickly than the inner region 1006, resulting in larger pore diameters near the surface of the gel monolith 1000 as compared to those in the inner region 1006 of the gel monolith 1000. This inhomogeneity of pore diameters can be evident by white, opaque features appearing at the surface of the gel monolith 1000, while the center of the gel monolith 1000 can remain relatively clear. In certain embodiments, the outer region 1008 is dried before the inner region 1006, and liquid 1004 from the inner region 1006 diffuses to the outer region 1008. In such embodiments, white, opaque features can be observed to form just inside the surface of the gel monolith 1000, with the inner region 1006 remaining transparent. As the outer region 1008 is dried further, more of the surface becomes white and opaque, with the inner region 1006 remaining transparent.

FIG. 18 is a flow diagram of an embodiment of the operational block 1160 in which substantially all of the remaining liquid 1004 is removed from the pores 1002 of the gel monolith 1000 in accordance with embodiments of the present invention. In an operational block 1162, the outer region 1008 of the gel monolith 1000 is exposed to a temperature within a fourth temperature range. In an operational block 1164, a temperature gradient between the outer region 1008 and the inner region 1006 is modulated. As is described more fully below, in certain embodiments, the outer region 1008 of the gel monolith 1000 is exposed to a temperature within the fourth temperature range until the gel monolith 1000 is substantially dried, with interim periods in which the outer region 1008 is exposed to higher temperatures in a fifth temperature range, thereby modulating a temperature gradient between the inner region 1006 and the outer region 1008. In certain embodiments, modulation of the temperature gradient comprises varying the magnitude of the temperature gradient, while in other embodiments, modulation further comprises varying the sign or direction of the temperature gradient relative to the inner region 1006 and the outer region 1008.

In certain embodiments, during the removal of substantially all of the remaining liquid 1004 in the operational block 1160, the gel monolith 1000 shrinks slightly (until the critical gel density ρ_{crit} is reached), and the liquid content of the gel monolith 1000 is reduced, thereby drying the gel monolith 1000. The fourth temperature range of the operational block 1162 is selected in certain embodiments to provide a rate of drying which minimizes inhomogeneities in the capillary forces and the overall stresses on the gel monolith 1000, thereby avoiding cracking of the gel monolith 1000. In certain such embodiments, the fourth temperature range corresponds to a rate of evaporation Θₑᵥₐₚ from the outer region 1008 that is substantially equal to or less than the rate of diffusion Θ_{diff} of liquid 1004 through the pores 1002 of the gel monolith 1000. Under such conditions, the liquid 1004 which evaporates from the surface of the gel monolith 1000 is replaced by liquid 1004 from the inner region 1006 of the gel monolith 1000. The gel monolith 1000 of such embodiments dries primarily by diffusion, with the liquid 1004 from the inner region 1006 diffusing to the outer region 1008.

In certain embodiments, the fourth temperature range is between approximately 10 degrees Celsius below and approximately 10 degrees Celsius above the boiling temperature of the liquid 1004. In certain other embodiments, the fourth temperature range is between approximately 5 degrees Celsius below and approximately 5 degrees Celsius above the boiling temperature of the liquid 1004. In still other embodiments, the fourth temperature range is between approximately the boiling temperature of the liquid 1004 and approximately 2 degrees Celsius above the boiling temperature of the liquid 1004. In the embodiment illustrated in FIG. 16, the temperature T₂ at time t₃ is within both the third temperature range and the fourth temperature range, thereby providing continuity between the operational block 1128 and the operational block 1162. Other embodiments compatible with the present invention can use a fourth temperature range that does not overlap with the third temperature range.

While FIG. 16 shows the temperature in the fourth temperature range to be generally constant, other embodiments compatible with the present invention can vary the temperature while staying in the fourth temperature range. In certain embodiments, the temperature is increased within the fourth temperature range at a rate between approximately 0.3 and 20 days per degree Celsius, while in other embodiments, the temperature increase rate is between approximately 1 and approximately 10 days per degree Celsius, and in still other embodiments, the temperature increase rate is between approximately 2 and approximately 5 days per degree Celsius. During such slowly-varying increases of the temperature, the inner region 1006 of the gel monolith 1000 remains at approximately the same temperature as is the outer region 1008 of the gel monolith 1000. Therefore, such slowly-increasing temperatures do not generate a substantial temperature gradient between the inner region 1006 and the outer region 1008 of the gel monolith 1000.

In certain embodiments, a temperature gradient between the outer region 1008 and the inner region 1006 is modulated in an operational block 1164 by exposing the outer region 1008 to a temperature within the fourth temperature range and exposing the outer region 1008 to a temperature within a fifth temperature range higher than the fourth temperature range. By exposing the outer region 1008 of the gel monolith 1000 to temperatures in the fifth temperature range while the inner region 1006 is effectively at a temperature within the fourth temperature range, a temperature gradient is generated between the inner region 1006 and the outer region 1008. Similarly, once the inner region 1006 is effectively at an elevated temperature above the fourth temperature range, by exposing the outer region 1008 to a temperature in the fourth temperature range, a temperature gradient is again generated between the inner region 1006 and the outer region 1008. As used herein, a temperature gradient in which the outer region 1008 is at a higher temperature than is the inner region 1006 is described as a positive temperature gradient, and a temperature gradient in which the outer region 1008 is at a lower temperature than is the inner region 1006 is described as a negative temperature gradient.

In the embodiment illustrated in FIG. 16, the rate of temperature increase or decrease between the fourth temperature range and the fifth temperature range is rapid enough to generate the temperature gradient between the inner region 1006 and the outer region 1008 of the gel monolith 1000. In certain embodiments, the temperature is increased or decreased approximately instantaneously by stepping the set point temperature of the oven between a temperature in the fourth temperature range and a temperature in the fifth temperature range and allowing the gel monolith 1000 to heat up or cool down in accordance with the modified temperature. In certain embodiments, the absolute value of the rate of temperature change is between approximately 60 degrees Celsius per hour and approximately 155 degrees Celsius per hour. In other embodiments, the absolute value of the rate of temperature change is approximately equal to 135 degrees Celsius per hour. Other embodiments can utilize nonlinear temperature changes between the fourth temperature range and the fifth temperature range. In certain embodiments, the absolute value of the temperature increase from the fourth to the fifth temperature range can be different from the absolute value of the temperature decrease from the fifth to the fourth temperature range.

In certain embodiments, the fifth temperature range is less than approximately 180 degrees Celsius. In other embodiments, the fifth temperature range is between approximately 100 degrees Celsius and approximately 150 degrees Celsius. In still other embodiments, the fifth temperature range is between approximately 120 degrees Celsius and approximately 130 degrees Celsius. In certain embodiments, the fifth temperature range corresponds to an evaporation rate Θₑᵥₐₚ of the liquid 1004 from the outer region 1008 which is greater than or equal to a diffusion rate Θ_{diff} of the liquid 1004 in the pores 1002 of the gel monolith 1000. Under such conditions, the outer region 1008 dries faster than does the inner region 1006 since liquid 1004 is removed from the outer region 1008 via evaporation faster than liquid 1004 is replaced by diffusion from the inner region 1006 to the outer region 1008. One result of such conditions is that the outer region 1008 becomes opaque before the inner region 1006 becomes opaque.

In the exemplary embodiment schematically illustrated in FIG. 16, the outer region 1008 is exposed to a temperature within the fourth temperature range for a period of time (t₄-t₃) between times t₃ and t₄. In certain such embodiments, the time period (t₄-t₃) between times t₃ and t₄ is sufficiently long so that at time t₄, the temperature of the inner region 1006 and the temperature of the outer region 1008 are both within the fourth temperature range. As described above, in certain embodiments the temperature applied to the outer region 1008 during the time period (t₄-t₃) between times t₃ and t₄ is constant or is varying sufficiently slowly so that the inner region 1006 remains at approximately the same temperature as is the outer region 1008. In such embodiments, there is not a substantial temperature gradient between the inner region 1006 and the outer region 1008 during the time period (t₄-t₃).

In embodiments in which the fourth temperature range corresponds to a rate of evaporation Θₑᵥₐₚ from the outer region 1008 that is substantially equal to or less than the rate of diffusion Θ_{diff} of liquid 1004 through the pores 1002, the liquid 1004 evaporating from the surface of the gel monolith 1000 is replaced by liquid 1004 from the inner region 1006 of the gel monolith 1000. In such embodiments, the outer region 1008 does not dry faster than does the inner region 1006 during the time period (t₄-t₃) between times t₃ and t₄.

At time t₄ in the exemplary embodiment of FIG. 16, the outer region 1008 is exposed to a temperature within the fifth temperature range, thereby generating a positive temperature gradient between the outer region 1008 and the cooler inner region 1006. This positive temperature gradient will exist for some time while the temperature within the fifth temperature range is applied, but the positive temperature gradient will decrease in magnitude as the inner region 1006 warms, eventually reaching zero once the inner region 1006 is at the same temperature as the outer region 1008 (i.e., once the inner region 1006 and outer region 1008 are equilibrated).

Because the rate of evaporation Θₑᵥₐₚ is proportional to temperature, the rate of evaporation Θₑᵥₐₚ from the outer region 1008 will be faster in the fifth temperature range than in the fourth temperature range. In embodiments in which the fifth temperature range corresponds to an evaporation rate Θₑᵥₐₚ which is greater than or equal to the diffusion rate Θ_{diff} for temperatures in the fourth temperature range, while the positive temperature gradient exists, liquid 1004 is removed from the outer region 1008 via evaporation faster than liquid 1004 is replaced by diffusion from the inner region 1006. During such times, the outer region 1008 dries faster than does the inner region 1006. In addition, the heat applied to the outer region 1008 is absorbed by the evaporating liquid 1004, thereby contributing to the temperature gradient between the outer region 1008 and the inner region 1006 by inhibiting the applied heat from diffusing to and warming the inner region 1006.

In the exemplary embodiment of FIG. 16, the outer region 1008 is exposed to a temperature in the fifth temperature range for a period of time (t₅-t₄) between t₄ and t₅. In certain embodiments, the outer region 1008 is exposed to a temperature in the fifth temperature range for a period of time between approximately 30 minutes and approximately 5 hours. In other embodiments, the outer region 1008 is exposed to a temperature in the fifth temperature range for a period of time between approximately one hour and approximately 2 hours. In still other embodiments, the outer region 1008 is exposed to a temperature in the fifth temperature range for a period of time between approximately 1.5 hours and approximately 2 hours.

In certain embodiments, the period of time (t₅-t₄) between t₄ and t₅ is selected to allow most, if not all, of the outer region 1008 to become opaque white before lowering the temperature. Such embodiments have a drier outer region 1008 and a wetter inner region 1006. Once the temperature is lowered, the liquid 1004 from various portions of the wetter inner region 1006 can diffuse into various portions of the drier outer region 1008 at approximately equal rates, thereby avoiding stresses in the gel monolith 1000.

The period of time during which the outer region 1008 is exposed to a temperature in the fifth temperature range can be described by examining the forces on the gel monolith 1000 in certain embodiments. While the positive temperature gradient exists between the outer region 1008 and the inner region 1006, there are two main forces acting on the gel monolith 1000: vapor pressure (tensile force) and capillary force (compressive force). While in the fifth temperature range, the outer region 1008 will have a net tensile force because the vapor pressure dominates over the capillary forces at these temperatures. Similarly, while in the fourth temperature range, the inner region 1006 will have a net compressive force because the capillary forces dominate at these temperatures. Gel monoliths 1000 comprising ceramics or oxide-based materials are more stable under compression than under tension. Therefore, certain such embodiments avoid cracking of the gel monolith 1000 by maintaining tensile forces which do not exceed compressive forces. The roles of compression and tension forces in gel monoliths is discussed further by Brinker & Scherer in “Sol-Gel Science, The Physics and Chemistry of Sol-Gel Processing,” pages 483-498, Academic Press, 1990, which is incorporated in its entirety by reference herein.

This condition of keeping tensile forces less than compressive forces can constrain the period of time during which the outer region 1008 is exposed to the fifth temperature range in certain embodiments. After a sufficiently long period of time, the entire gel monolith 1000, including the inner region 1006, will be at a temperature within the fifth temperature range. Under such conditions, there is no longer a temperature gradient between the outer region 1008 and the inner region 1006, and the vapor pressure dominates over the capillary forces across the gel monolith 1000. Thus, the gel monolith 1000 will be under tension and can crack. Therefore, in accordance with embodiments of the present invention, the outer region 1008 is exposed to a temperature within the fifth temperature range only for relatively short periods of time so as to avoid conditions for cracking.

At time t₅ in the exemplary embodiment of FIG. 16, the outer region 1008 is exposed to a temperature within the fourth temperature range, thereby cooling the outer region 1008. In embodiments in which the outer region 1008 becomes cooler than the inner region 1006, a negative temperature gradient is generated between the outer region 1008 and the warmer inner region 1006. This negative temperature gradient will exist for some time while the temperature within the fourth temperature range is applied, but the negative temperature gradient will decrease in magnitude as the inner region 1006 cools, eventually reaching zero once the inner region 1006 is at the same temperature as the outer region 1008.

In embodiments in which the outer region 1008 does not reach temperatures below that of the inner region 1006, cooling the outer region 1008 reduces the magnitude of the positive temperature gradient and hastens the equalization of temperatures between the outer region 1008 and the inner region 1006. Whether the outer region 1008 reaches temperatures below that of the inner region 1006 is dependent on details of the temporal temperature profile, such as the temperatures applied and the periods of time that the temperatures were applied.

By allowing the outer region 1008 to cool, the rate of evaporation Θₑᵥₐₚ is reduced and the temperature gradient gradually decreases in magnitude, eventually reaching zero. Once both the inner region 1006 and outer region 1008 are again at temperatures within the fourth temperature range, the gel monolith 1000 dries primarily by diffusion and the overall stresses on the gel monolith 1000 are minimized. As described above, the liquid 1004 from the inner region 1006 diffuses to the drier, outer region 1008.

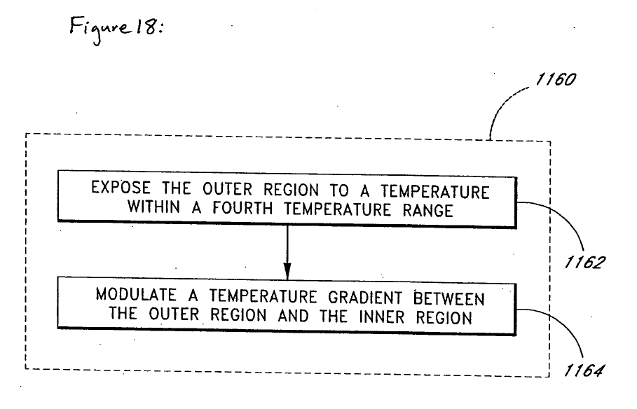

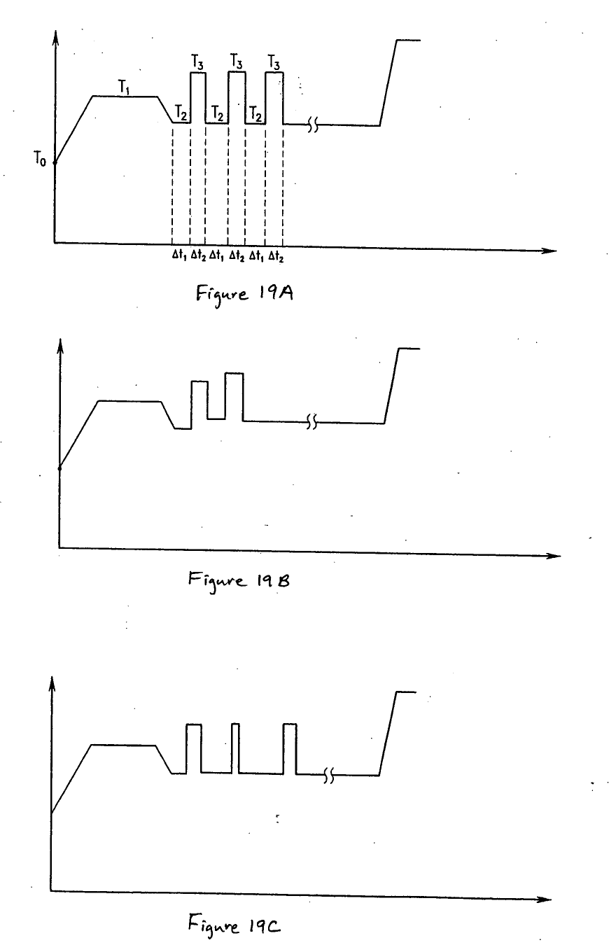

FIGS. 19A-19C schematically illustrate other temporal temperature profiles in accordance with embodiments of the present invention. In certain embodiments, modulating the temperature gradient between the inner region 1006 and the outer region 1008 further comprises cycling the temperature through a plurality of cycles. Each cycle comprises exposing the outer region 1008 to the fourth temperature range for a first time period, increasing the temperature from the fourth temperature range to the fifth temperature range, and exposing the outer region to the fifth temperature range for a second time period. The temperature is increased between the fourth temperature range and the fifth temperature range at a rate to generate a substantial temperature gradient between the outer region and the inner region.

In certain embodiments, each cycle has substantially the same parameters as do the other cycles. For example, the temporal temperature profile illustrated in FIG. 19A comprises three cycles. Each cycle exposes the outer region 1008 to a temperature T₂ within the fourth temperature range for a first time period Δt₁ and exposes the outer region 1008 to a temperature T₃ within the fifth temperature range for a second time period Δt₂. In addition, the rates of temperature increase and decrease for each cycle are substantially the same, and are sufficiently rapid to generate substantial temperature gradients between the outer region and the inner region, as described above.

While the embodiment illustrated in FIG. 19A comprises three cycles, other embodiments compatible with the present invention comprise two, four, or more cycles. In addition, other temporal temperature profiles in accordance with embodiments of the present invention can comprise cycles with differing first time periods, second time periods, temperatures, or rates of temperature increase or decrease. For example, FIG. 19B illustrates an embodiment comprising two cycles with differing temperatures, and FIG. 19C illustrates an embodiment comprising three cycles with differing first time periods and differing second time periods.

In certain embodiments, the first time period is between approximately one hour and approximately 30 hours. In certain other embodiments, the first time period is between approximately 5 hours and approximately 20 hours.

In certain embodiments, the second time period is between approximately 10 minutes and approximately 15 hours. In certain other embodiments, the second time period is between approximately 10 minutes and approximately 10 hours. In still other embodiments, the second time period is between approximately 1.5 hours and approximately 2 hours.

In certain embodiments, as schematically illustrated in FIGS. 16 and 19A-19C, the temporal temperature profile also comprises a relatively brief exposure of the gel monolith 1000 to high temperatures once the gel monolith 1000 is dried (i.e., the liquid 1004 has been completely driven from the pores 1002 of the gel monolith 1000). This period of heightened temperatures is used to drive the remaining vapor from the pores 1002 of the gel monolith 1000. In certain such embodiments, the temperature is ramped up to approximately 180 degrees Celsius over a period of approximately 18 hours, and is held at this heightened temperature for approximately 3 hours to approximately 10 hours. In addition, to facilitate the removal of vapor from the pores 1002 of the gel monolith 1000, certain embodiments comprises backfilling the drying oven with an inert gas, nitrogen, air, or a combination thereof, at atmospheric pressure during this exposure to high temperatures.

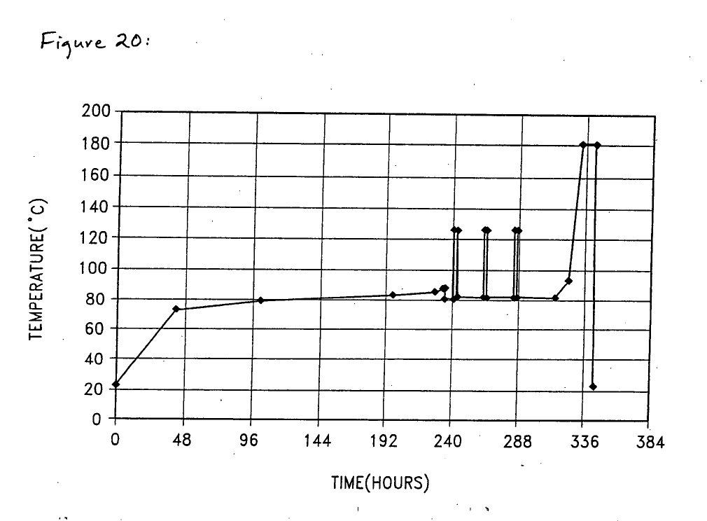

FIG. 20 schematically illustrates an exemplary temporal temperature profile which was applied to a gel monolith 1000 in accordance with embodiments of the present invention. The gel monolith 1000 was formed from a sol-gel solution comprising a formulation with a mole ratio of TEOS:Ge:ethanol:HF:water of 1:0.105:2.5:0.25:2.2. At time t₀, removing a portion of the liquid 1004 from the pores 1002 of the gel monolith 1000 began by placing the wet porous gel monolith 1000 in the drying oven and exposing the gel monolith 1000 to a temperature of approximately 23 degrees Celsius, which is within the first temperature range of certain embodiments. The temperature in the drying oven was then increased linearly, eventually reaching a temperature of approximately 72 degrees Celsius after approximately 40 hours. For the next approximately 194 hours, the outer region 1008 was exposed to a temperature which increased generally linearly from approximately 72 degrees Celsius to approximately 87 degrees Celsius, which is within the second temperature range of certain embodiments. During this period of increasing temperature, the temperature increased from the first temperature range to the second temperature range which is substantially above the boiling temperature of the liquid 1004 (approximately 78 degrees Celsius for ethanol) and the temperature was maintained within the second temperature range for a period of time (while still increasing).

Approximately 235 hours after placing the gel monolith 1000 in the drying oven, the temperature was reduced from approximately 87 degrees Celsius to approximately 80 degrees Celsius, which is within the third temperature range of certain embodiments. During the removal of the portion of the liquid 1004, the volume of the gel monolith 1000 shrank, with the gel monolith 1000 becoming correspondingly more dense.

Once the temperature reached approximately 80 degrees Celsius, removal of substantially all of the remaining liquid 1004 from the pores 1002 of the gel monolith 1000 began. For approximately 6 hours, the outer region 1008 was exposed to a temperature of approximately 80 degrees Celsius, which is within the fourth temperature range of certain embodiments, and a temperature gradient between the outer region 1008 and the inner region 1006 was then modulated by cycling the temperature through a plurality of cycles.

Modulating the temperature gradient began with a first temperature cycle comprising the approximately 6-hour exposure of the outer region 1008 to approximately 80 degrees Celsius, which is within the fourth temperature range of certain embodiments. The first temperature cycle further comprised increasing the temperature from the fourth temperature range to a temperature of approximately 125 degrees Celsius, which is within the fifth temperature range of certain embodiments. The first temperature cycle further comprised exposing the outer region 1008 to the fifth temperature range for approximately 2.5 hours.

Modulating the temperature gradient continued with two additional temperature cycles. Each of these cycles comprises exposing the outer region 1008 to approximately 80 degrees Celsius for approximately 20 hours, increasing the temperature to approximately 125 degrees Celsius, and exposing the outer region 1008 to this temperature for approximately 2.5 hours. The temperature was then reduced and maintained at approximately 80 degrees Celsius for approximately 28 hours. The temporal temperature profile also comprises a relatively brief exposure of the gel monolith 1000 to high temperatures once the gel monolith 1000 was dried to drive the remaining vapor from the pores 1002. The oven was backfilled with nitrogen gas and the temperature was ramped up to approximately 180 degrees Celsius over a period of approximately 17 hours, and was held at approximately 180 degrees Celsius for approximately 10 hours. The temperature was then reduced back to approximately room temperature (approximately 23 degrees Celsius) under the nitrogen gas atmosphere.

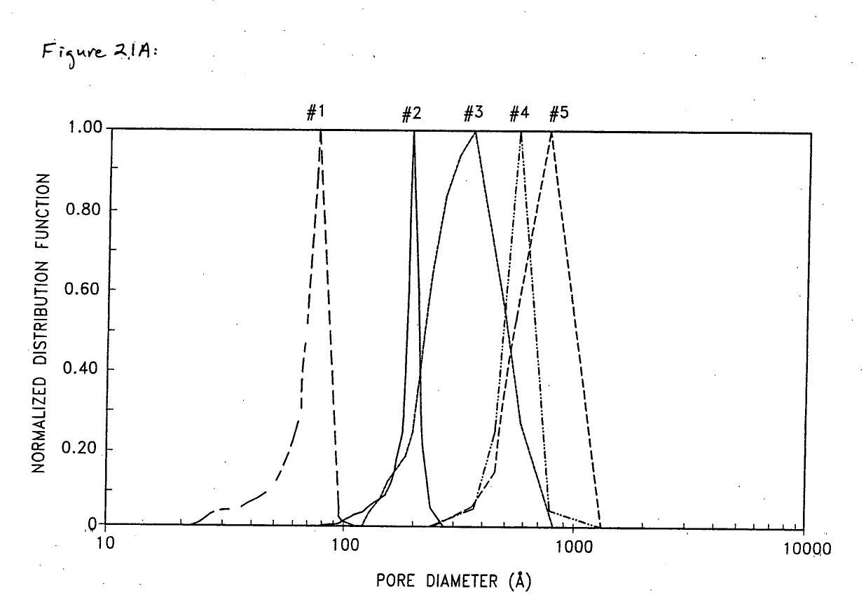

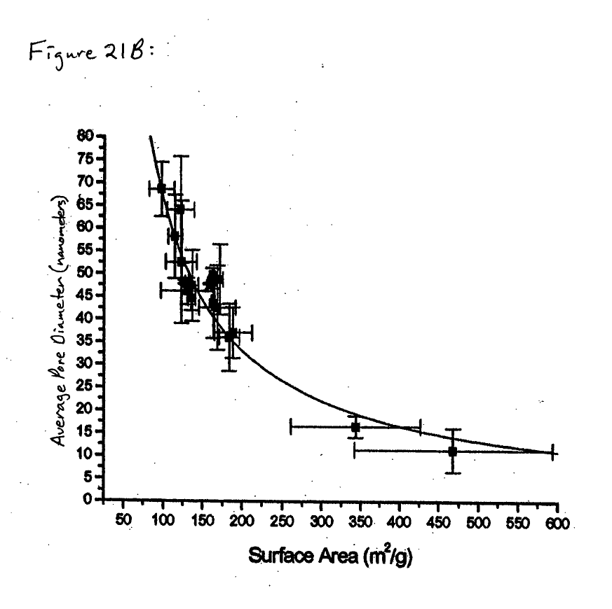

FIG. 21A graphically illustrates the resultant pore diameter distributions for five different solution formulations after drying in accordance with embodiments of the present invention. Table 1 provides information regarding these five solution formulations and the resultant pore diameter distributions. In addition to the listed formulation, each of the solutions of FIG. 21A and Table 1 have a formulation with a mole ratio of TEOS:ethanol:water of 1:2:2.

TABLE 1

| | | | Pore | Average | % of Pores | Mode | % of Pores |
|---|---|---|---|---|---|---|---|
| | | Pore | Surface | Pore | Within ±10%, | Pore | Within ±10%, |
| | Formulation | Volume | Area | Diameter | ±30%, ±45% | Diameter | ±30%, ±45% |
| Monolith | (mole ratio) | (cc/g) | (m²/g) | (Å) | of Average | (Å) | of Mode |
| A | HF 0.12 | 1.167 | 518.1 | 90.1 | 35% | 78 | 70% |
| | | | | | 85% | | 95% |
| | | | | | 100% | | 100% |
| B | HF 0.16 | 1.812 | 244.2 | 296.9 | 5% | 198 | 65% |
| | | | | | 80% | | 95% |
| | | | | | 100% | | 100% |
| C | HF 0.25 | 3.67 | 292.4 | 501.4 | 15% | 374 | 15% |
| | Ge 0.105 | | | | 45% | | 40% |
| | | | | | 100% | | 90% |
| D | HF 0.34 | 3.32 | 180.8 | 735 | 20% | 587 | 50% |
| | | | | | 65% | | 95% |
| | | | | | 100% | | 100% |
| E | HF 0.4 | 2.66 | 95.74 | 1114 | 20% | 809 | 30% |
| | | | | | 60% | | 90% |
| | | | | | 100% | | 100% |

Each of the xerogel monoliths of FIG. 21A and Table 1 was prepared in accordance with embodiments of the present invention as described herein. In certain embodiments, a sol comprising metal alkoxide and a catalyst at a catalyst concentration is first formed. The sol is then gelled to form a wet gel monolith, which is dried and shrunk by exposing the wet gel monolith to a temporal temperature profile, thereby forming a xerogel monolith. The catalyst, the catalyst concentration, and the temporal temperature profile for such embodiments are controlled and preselected to obtain the xerogel monolith having certain physical properties.

The pore diameter distributions of FIG. 21A and Table 1 were measured using either an Autosorb-6B or Autosorb-3B surface area and pore size analyzer manufactured by Quantachrome Corporation of Boynton Beach, Fla. As described above, and as seen in FIG. 21A and Table 1, the mean pore diameters of xerogel monoliths fabricated in accordance with embodiments of the present invention correlate generally with the concentration of the catalyst HF in the solution.

In certain embodiments, the resultant xerogel monolith has a pore diameter distribution with an average pore diameter between approximately 200 Å and approximately 1500 Å. In certain such embodiments, the average pore diameter is between approximately 400 Å and approximately 1500 Å, while in certain other embodiments, the mean pore diameter is between approximately 1000 Å and approximately 1500 Å. Similarly, in certain embodiments, the resultant xerogel monolith has a pore diameter distribution with a mode pore diameter between approximately 200 Å and approximately 1500 Å.

In certain embodiments, at least 20% of the pores of the resultant xerogel monolith have diameters within approximately ±10% of the average pore diameter. In certain other embodiments, at least 45% of the pores of the resultant xerogel monolith have diameters within approximately ±30% of the average pore diameter. In certain embodiments, at least 30% of the pores have diameters within approximately ±10% of the mode pore diameter, while in certain other embodiments, at least 90% of the pores have diameters within approximately ±30% of the mode pore diameter.

FIG. 21B schematically illustrates the relationship between the pore sizes and the surface area of the pores of the gel monolith by plotting the measured average pore diameters and the pore surface areas for various gel monoliths formed in accordance with embodiments described herein. Generally, smaller pore sizes correspond to larger surface areas, and larger pore sizes correspond to smaller surface areas.

Consolidating the Halogen-Doped Gel Monolith

Once dried, the gel monolith is densified into an optical-quality glass monolith by a consolidating process (i.e., sintering). The glass phase is characterized by an amorphous structure. Alternatively, in other embodiments, the densification can result in a monolith which has a crystalline structure. The consolidating process can result in further linear shrinkage of the monolith, eventually reaching approximately 60% (i.e., to 40% of the starting size of the wet gel monolith).

Consolidation is performed by placing the dry gel monolith in a furnace and exposing it to a consolidating temporal temperature profile in an atmosphere comprising various gases. Numerous consolidating temporal temperature profiles and atmospheres are compatible with embodiments of the present invention, including those described by Kirkbir, et al., in U.S. Pat. No. 5,254,508, which is incorporated in its entirety by reference herein, for consolidating gel monoliths for optical fiber preforms. As described by Kirkbir, et al., the consolidating temporal temperature profile and atmospheres can be chosen to fabricate optical fiber preforms which undergo reduced bubbling of the germanium-doped core portion during the high-temperature fiber drawing process.

FIG. 22 is a flowchart of an exemplary consolidating process 1200, in accordance with embodiments of the present invention, performed on a monolith in a furnace. In an operational block 1210, the monolith is exposed to an atmosphere comprising oxygen and nitrogen and heated slowly from room temperature to a temperature of no more than 1000 degrees Celsius. The operational block 1210 of certain embodiments can comprise intermittent periods at which the temperature is held constant. For example, in certain embodiments, the operational block 1210 comprises maintaining the temperature at approximately 160 degrees Celsius for two hours, at approximately 240 degrees Celsius for 20 hours, raising the temperature to approximately 700 degrees Celsius in 30 hours, and holding at this temperature for 39 hours. In addition, the monolith can also be exposed to intermittent vacuum treatments during the operational block 1210. These intermittent vacuum treatments, in which the monolith is exposed to pressures of less than approximately atmospheric pressure for periods of time between approximately 10 minutes and approximately 10 hours, can serve to shorten the overall time the monolith is exposed to the conditions of the operational block 1210. In certain embodiments, the monolith is exposed to absolute pressures of approximately 0.7 psi (i.e., approximately −14 psi relative to atmospheric pressure) during the operational block 1210.

The processing step of the operational block 1210 can remove unwanted molecules from the pore surfaces of the monolith. This removal of impurities can be considered to be part of the consolidation process, part of the process of formation of the gel monolith, or a separate procedure from either consolidation or formation. In certain embodiments, these unwanted molecules can include, but are not limited to, organic species, corrosive effluent molecules such as HF, and byproducts of the hydrolysis and polymerization reactions, such as alcohol, H₂O, or hydrocarbons. In embodiments having a Ge-doped monolith, this processing step can also remove GeF₂, GeF₄, or GeCl₄ from the pore surfaces of the monolith.

In certain embodiments, the consolidating process 1200 further comprises an operational block 1220 in which the monolith is exposed to a halogen-containing gas treatment while at a temperature between approximately 600 degrees Celsius and approximately 1100 degrees Celsius. By exposing the gel monolith to such an atmosphere prior to collapse of the pores, this processing step can remove hydroxyl groups (OH) from the pore surfaces of the monolith which would otherwise degrade the optical performance of the resultant glass. In addition, this processing step can remove unwanted free GeO molecules from a Ge-doped monolith.

In certain embodiments of the operational block 1220, the monolith is exposed to a gas comprising an inert gas (such as helium or nitrogen), and at least 0.1% of a halogen-containing gas such as chlorine gas (Cl₂). In certain embodiments, the gas further comprises oxygen. In still other embodiments, the gas comprises approximately 10% by volume of Cl₂ and approximately 90% by volume of O₂. Other halogen-containing gases compatible with embodiments of the present invention include, but are not limited to, SiF₄, NF₃, SF₆, HF, SOCl₂, CCl₄, and SiCl₄.

The temperature during the operational block 1220 of certain embodiments can be held constant, or can be varied with a predetermined temporal temperature profile. For example, in certain embodiments, the operational block 1220 comprises holding the temperature at approximately 700 degrees Celsius for 5 hours, increasing to approximately 800 degrees Celsius in 10 hours, holding at approximately 800 degrees Celsius for 5 hours, increasing to approximately 900 degrees Celsius in 10 hours, and holding at this temperature for 10 hours.

In certain embodiments, exposing the gel monolith to the chlorine gas is performed prior to collapse of the pores. In this way, trapping of chlorine gas within the resultant glass and formation of bubbles within the glass is avoided. As described above in relation to the operational block 1210, the operational block 1220 of certain embodiments can comprise one or more intermittent vacuum treatments which can shorten the overall time the monolith is exposed to the conditions of the operational block 1220 and can remove the chlorine gas from the atmosphere before collapse of the pores during consolidation to avoid bubble formation. In contrast, Shibata et al., in “Fabrication of Fluorine-Doped Silica Glasses by the Sol-Gel Method,” Journal of Non-Crystalline Solids, Vol. 100, 1988, pp. 269-273, which is incorporated in its entirety by reference herein, discloses consolidating a gel monolith into glass in an atmosphere containing 5-10% of oxygen and 1-2% of chlorine gases. Such a procedure would result in trapping of gas within the resultant glass and would have a significantly high chlorine impurity concentration.

In certain embodiments, the consolidating process 1200 further comprises an operational block 1230 in which the monolith is exposed to an oxygen-containing gas treatment while at a temperature less than approximately 1150 degrees Celsius. This processing step can remove chlorine from the monolith and burn off residual carbon atoms. In certain embodiments, the oxygen-containing gas comprises at least 10% oxygen (O₂), with the balance comprising helium or nitrogen or both. The temperature during the operational block 1230 of certain embodiments can be held constant, or can be varied with a predetermined temporal temperature profile. For example, in certain embodiments, the operational block 1230 comprises maintaining the temperature at 900 degrees Celsius for 29 hours, increasing to 1020 degrees Celsius in 10 hours, and increasing to 1040 degrees Celsius in 20 hours. As described above, the operational block 1230 of certain embodiments can comprise one or more intermittent vacuum treatments which can shorten the overall time the monolith is exposed to the conditions of the operational block 1230.

In certain embodiments, the consolidating process 1200 further comprises an operational block 1240 in which the monolith is exposed to a helium gas purge treatment which can remove oxygen gas from the pores of the monolith. In addition, for Ge-doped monoliths, embodiments of the operational block 1240 can remove unwanted free GeO₂ molecules from the monolith. In certain embodiments, this processing step lasts at least 30 minutes during a temperature less than approximately 1150 degrees Celsius. As described above, the operational block 1240 of certain embodiments can comprise one or more intermittent vacuum treatments which can shorten the overall time the monolith is exposed to the conditions of the operational block 1240.

In certain embodiments, the consolidating process 1200 further comprises an operational block 1250 in which the monolith is heated to a temperature of at least 1150 degrees Celsius for at least 5 minutes. This processing step can densify and consolidate the monolith into optical quality glass. In certain embodiments, the temperature is increased from the temperature of the operational block 1240 at a rate of at least approximately 10 degrees Celsius per hour. For example, in certain embodiments, the operational block 1250 comprises increasing the temperature to approximately 1160 degrees Celsius in 12 hours, increasing to approximately 1280 degrees Celsius in 15 hours, maintaining at approximately 1280 degrees Celsius for 10 hours, and decreasing to approximately 1120 degrees Celsius in 2 hours. In certain embodiments, this processing step is performed in vacuum, while in other embodiments, it is performed in an atmosphere of helium gas to facilitate heat transfer during consolidation.

In certain embodiments, the consolidating process 1200 further comprises an operational block 1260 in which the monolith is cooled down to room temperature in a nitrogen or helium gas environment. In certain embodiments, the operational block 1260 comprises cooling to approximately 1120 degrees Celsius in 6 hours, cooling to approximately 850 degrees Celsius in 26 hours, cooling to approximately 500 degrees Celsius in 18 hours, and cooling freely to approximately 20 degrees Celsius. Other embodiments can utilize other temporal temperature profiles which avoid stresses which would otherwise result in poor optical quality of the monolith.

Below are described particular examples of consolidating temperature profiles and the atmospheres in accordance with embodiments of the present invention:

### EXAMPLE 1

For 27 hours, a dry silica gel monolith was heated from room temperature (approximately 20 degrees Celsius) to 400 degrees Celsius in an atmosphere of 20% oxygen and 80% nitrogen. The monolith was then heated to 700 degrees Celsius in 45 hours in an atmosphere of 40% oxygen and 60% nitrogen. The monolith was then heated to 800 degrees Celsius in 5 hours, then to 900 degrees Celsius in 10 hours, and held at this temperature for 10 hours in an atmosphere of 10% chlorine and 90% helium. The monolith was then held at 900 degrees Celsius for 95 hours in an atmosphere of 80% oxygen and 20% helium. The monolith was then heated to 1000 degrees Celsius in 15 hours in an atmosphere of 10% oxygen and 90% helium, and held at 1000 degrees Celsius for 8.5 hours in pure helium. The monolith was then heated in an atmosphere of helium to a temperature of 1280 degrees Celsius in one hour and held at that temperature for 8 minutes. The monolith was then allowed to cool to room temperature over the course of 24 hours in a nitrogen atmosphere. The resultant monolith was thus consolidated into an optical quality sol-gel-derived silica glass.

### EXAMPLE 2

For 18 hours, a dry Ge-doped silica gel monolith was heated from room temperature to 160 degrees Celsius and then to 400 degrees Celsius in an atmosphere of 20% oxygen and 80% nitrogen. The monolith was then heated to 700 degrees Celsius in 25 hours and held at that temperature for 20 hours in an atmosphere of 40% oxygen and 60% nitrogen. In an atmosphere of 10% chlorine and 90% helium, the monolith was heated to 800 degrees Celsius in 10 hours. The monolith was then heated to 900 degrees Celsius in 10 hours, and held at 900 degrees Celsius for 5 hours in an atmosphere of 6% chlorine and 94% oxygen. The monolith was then heated to 950 degrees Celsius in 10 hours and held at 950 degrees Celsius for 25 hours in an atmosphere of 80% oxygen and 20% helium. The monolith was then heated in an atmosphere of helium at a temperature of 950 degrees Celsius for 10 hours and then heated to 1100 degrees Celsius in 5 hours and further heated to a temperature of 1280 degrees Celsius in one hour and held at that temperature for 10 minutes. Upon cooling to room temperature in helium, the resultant monolith was thus consolidated into an optical quality sol-gel-derived Ge-doped silica glass.

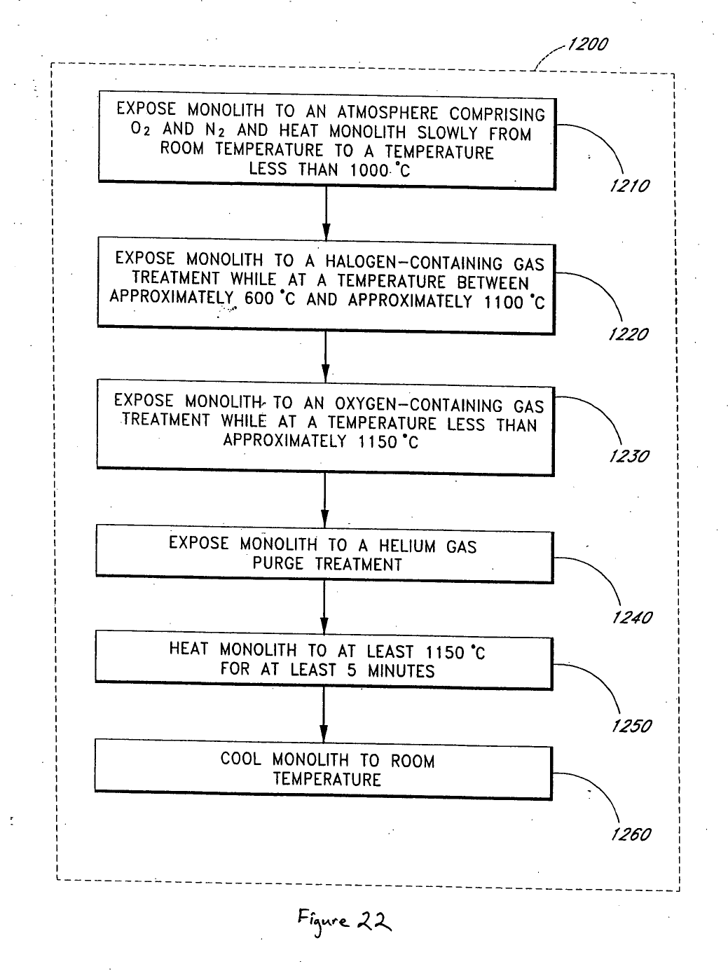

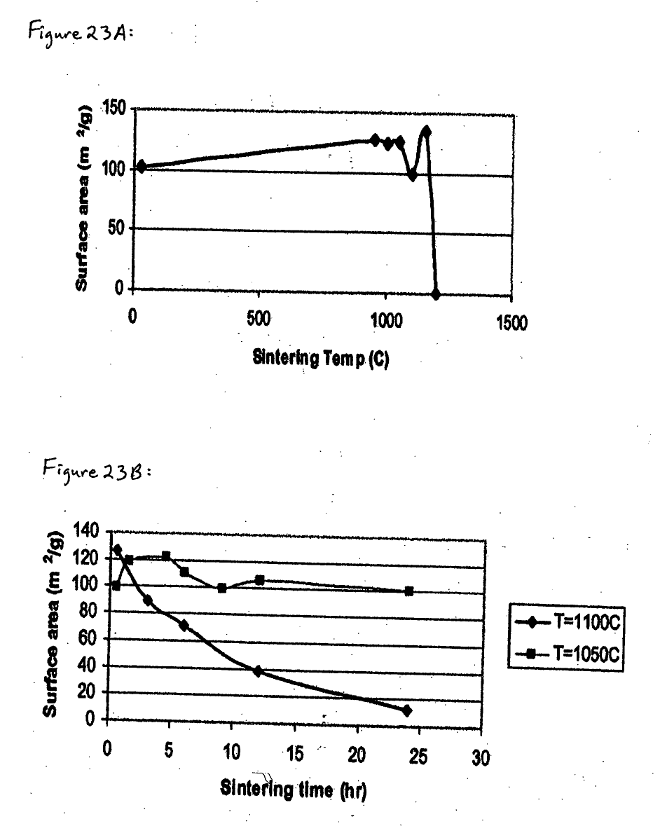

FIG. 23A is a graph of the measured pore surface area of a gel monolith as a function of the consolidation temperature. As the temperature is increased, hydroxyl groups are liberated from the gel monolith, allowing more precise measurements of the pore surface area of the gel monolith. FIG. 23A illustrates this temperature range as being from approximately room temperature to approximately 1000 degrees Celsius, in which the measured pore surface area is linearly increasing. The measured pore surface area experiences a dip at approximately 1050 degrees Celsius and a peak at approximately 1100 degrees Celsius. Upon exposure to higher temperatures, the gel monolith is consolidated and the pores collapse so that the measured pore surface area approaches zero.

FIG. 23B is a graph of the measured pore surface area as a function of time for two selected consolidation temperatures. For a consolidation temperature of approximately 1050 degrees Celsius, the measured pore surface area undergoes a relatively small decrease over the course of 24 hours. For a consolidation temperature of approximately 1100 degrees Celsius, the measured pore surface undergoes significant reductions due to the consolidation of the gel monolith.

In certain embodiments with a fluorine-doped gel monolith, the fluorine-doped monolith can react with oxygen or chlorine molecules while heating the fluorine-doped monolith to high temperatures during the consolidation process. Under such condition, the fluorine-doped monolith can lose fluorine by decomposing and generating gases (such as SiOClF or SiCl₂F₂) which liberate fluorine from the fluorine-doped monolith. Thus, a gel monolith having a first halogen content is consolidated into a glass having a second halogen content, wherein the second halogen content is less than the first halogen content.

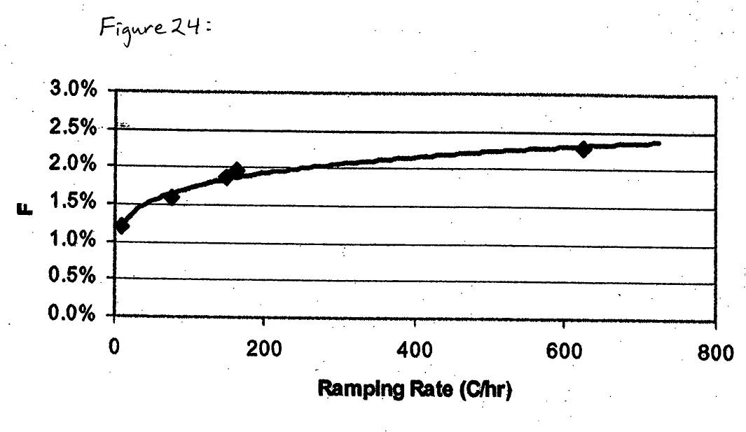

FIG. 24 is a graph of the fluorine content of resultant glass monoliths as a function of the ramping rate of the consolidation temperature. Each measurement of FIG. 24 started at approximately 700 degrees Celsius and had the same final consolidation temperature (1300 degrees Celsius). However, each measurement reached this final consolidation temperature in different times, due to the different ramping rates. As illustrated by FIG. 24, the fluorine content of the glass monolith was lower for longer consolidation processes (i.e., slower ramp rates of the consolidation temperature). The faster consolidation process left less time to allow the fluorine to be liberated from the gel monolith, so the fluorine content of the resultant glass monolith is correspondingly higher. Therefore, the ramp rate of the consolidation temperature can be used to tailor the fluorine content of the glass monolith resulting from the consolidation of a fluorine-doped gel monolith.

To impede this loss mechanism of fluorine, the fluorine-doped gel monolith of certain embodiments is exposed to a fluorine-containing gas during the consolidation process. In certain such embodiments, the consolidation furnace is backfilled with a fluorine-containing gas during the consolidation process. In certain such embodiments, the fluorine-containing gas impedes the loss of fluorine from the gel monolith such that the fluorine content of the resultant glass is less than the fluorine content of the initial gel monolith but it is larger than if the fluorine-containing gas were not used. In certain other embodiments, using the fluorine-containing gas impedes the loss of fluorine such that the fluorine content of the resultant glass is substantially equal to the fluorine content of the initial gel monolith. In such embodiments, little or none of the fluorine is lost from the gel monolith during the consolidation process. The fluorine-containing gas can also provide fluorine atoms which replace OH radicals in the structure of the gel monolith. Examples of fluorine-containing gases compatible with embodiments of the present invention include, but are not limited to, silicon tetrafluoride (SiF₄) or sulphur hexafluoride (SF₆).

Outside-vapor-deposition (OVD) methods have previously been disclosed to form fluorine-doped glass by exposing an OVD soot preform at high temperatures (e.g., greater than 1150 degrees Celsius) to CF₄, or some other fluorine-containing gas. At these temperatures, such OVD-based methods seek to increase the fluorine content of the preform by bonding gas-phase fluorine into the preform. For example, methods such as those disclosed by U.S. Pat. No. 6,492,072 to Moore et al., U.S. Pat. No. 6,541,168 to Brown et al., and U.S. Pat. No. 6,606,883 to Hrdina et al., each of which is incorporated in its entirety by reference herein, result in glass which has a significantly higher fluorine content than did the OVD soot preform. At the high temperatures of these OVD-based methods, the pores of the sol-gel-derived monoliths described herein are already beginning to collapse as part of the consolidation process (see, e.g., FIGS. 23A and 23B). Similarly, Shibata et al., in “Fabrication of F-Doped Silica Glasses by the Sol-Gel Method,” Japanese Journal of Applied Physics, Vol. 25, No. 11, November 1986, pp. L902-L904, which is incorporated in its entirety by reference herein, discloses doping the resultant glass with fluorine by exposing non-doped silica sol-gel to SF₆ gas during consolidation.

In contrast to these previous methods, certain embodiments of the present invention expose a fluorine-doped gel monolith at lower temperatures (e.g., 800-1000 degrees Celsius) to a fluorine-containing atmosphere to reduce the evaporation rate of fluorine-containing species from the pores of the fluorine-doped gel monolith. The fluorine-containing atmosphere maintains an elevated equilibrium partial pressure of the fluorine-containing species so that existing fluorine is not lost from the gel monolith during consolidation. Since fluorine is not being introduced into the gel monolith at these temperatures, such embodiments do not result in a fluorine content of the glass which is significantly larger than the fluorine content of the gel monolith.

FIG. 25 is a flowchart of a method 1300 of fabricating a halogen-doped glass in accordance with embodiments of the present invention. The halogen can comprise fluorine, iodine, bromine, or a combination of one or more of these elements. In an operational block 1310, a gel monolith is provided, the gel monolith having a first halogen content. In an operational block 1320, the gel monolith is consolidated into a glass having a second halogen content. The second halogen content is less than or equal to the first halogen content.

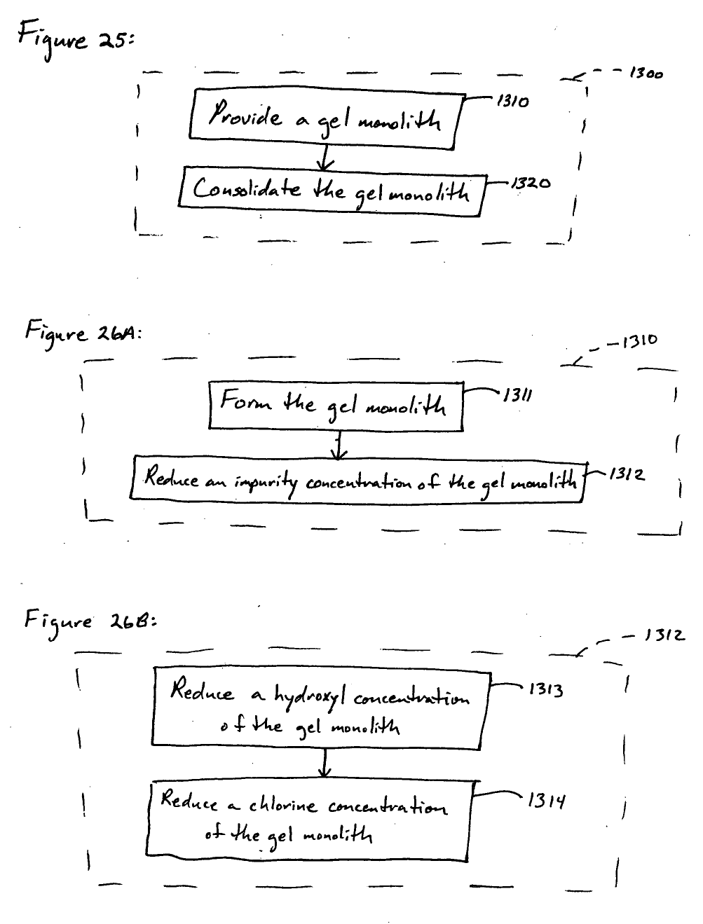

FIG. 26A is a flowchart of one embodiment of the operational block 1310. In an operational block 1311, providing the gel monolith comprises forming the gel monolith. In certain embodiments, the gel monolith is formed as described above in relation to FIGS. 10-12, 15, 17, and 18. In certain embodiments, the gel monolith comprises pores with an average pore diameter between approximately 10 nanometers and approximately 100 nanometers. In certain other emboidments, the gel monolith comprises pores with an average surface area between approximately 80 square meters per gram and approximately 700 square meters per gram.

In an operational block 1312, providing the gel monolith further comprises reducing an impurity concentration of the gel monolith. While in certain embodiments, providing the gel monolith can be considered to comprise reducing the impurity concentration of the gel monolith, in other embodiments, the reduction of the impurity concentration is a separate procedure from providing the gel monolith.

FIG. 26B is a flowchart of one embodiment of the operational block 1312. In an operational block 1313, reducing the impurity concentration of the gel monolith comprises reducing a hydroxyl concentration of the gel monolith by heating the gel monolith at a first elevated temperature while the gel monolith is exposed to a first atmosphere having a chlorine (Cl₂) concentration. In certain embodiments, the first elevated temperature is between approximately 400 degrees Celsius and approximately 1000 degrees Celsius, while in other embodiments, the first elevated temperature is between approximately 400 degrees Celsius and approximately 700 degrees Celsius. In certain embodiments, the first elevated temperature is ramped. The first atmosphere of certain embodiments has a pressure less than atmospheric pressure. In certain embodiments, the chlorine concentration is between approximately 3% and approximately 20%, while in other embodiments, the chlorine concentration is approximately 10%. After consolidation, the resultant glass of certain embodiments has an OH content below approximately one part per million.

In an operational block 1314, reducing the impurity concentration of the gel monolith further comprises reducing a chlorine concentration of the gel monolith. In certain embodiments, reducing the chlorine concentration comprises heating the gel monolith at a second elevated temperature while the gel monolith is exposed to a second atmosphere having an oxygen (O₂) concentration. In certain embodiments, the second elevated temperature is between approximately 700 degrees Celsius and approximately 950 degrees Celsius. In certain embodiments, the second elevated temperature is ramped. The second atmosphere of certain embodiments has a pressure less than atmospheric pressure. In certain embodiments, the oxygen concentration is between approximately 30% and approximately 100%, while in other embodiments, the oxygen concentration is approximately 50%. After consolidation, the resultant glass of certain embodiments has a chlorine content below approximately 100 parts per million.

In certain embodiments, consolidating the gel monolith in the operational block 1320 comprises ramping the temperature of the gel monolith at a ramp rate such that the second halogen content of the glass is at least approximately 0.5 wt. % fluorine. The ramp rate of certain such embodiments is between approximately 10 degrees Celsius per hour and approximately 150 degrees Celsius per hour.

In certain embodiments in which the halogen comprises fluorine, consolidating the gel monolith in the operational block 1320 further comprises heating the gel monolith to an elevated temperature while being exposed to an atmosphere comprising a fluorine-containing gas. In certain such embodiments, the fluorine-containing gas comprises one or more of the following gases: SiF₄, SiHF₃, SiH₂F₂, SiH₃F, CF₄, CHF₃, CH₂F₂, CH₃F, C₂F₆, C₂HF₅, C₂H₂F₄, C₂H₃F₃, C₂H₄F₂, C₂H₅F, SF₆, SHF₅, SH₂F₄, SH₃F₃, SH₄F₂, SH₅F, HF, and F₂.

In certain embodiments, the elevated temperature is between approximately 800 degrees Celsius and approximately 1250 degrees Celsius, while in other embodiments, the elevated temperature is between approximately 950 degrees Celsius and approximately 1100 degrees Celsius. In still other embodiments, the elevated temperature is ramped.

The atmosphere of certain embodiments has a pressure less than atmospheric pressure. The fluorine-containing gas concentration of certain embodiments is between approximately 10% and approximately 80%, while in other embodiments, the fluorine-containing gas concentration is between approximately 20% and approximately 50%. In still other embodiments, the fluorine-containing gas concentration is sufficient to reduce liberation of fluorine from the gel monolith during consolidation. The atmosphere of certain embodiments further comprises argon, neon, helium, nitrogen, or other relatively inert gases. The fluorine-containing gas of certain embodiments is introduced to the gel monolith so as to maintain a constant elevated partial pressure. For example, the incoming flow and the exhaust flow can be controlled to maintain a constant flow rate of the fluorine-containing gas in the consolidation chamber.

In embodiments in which the halogen comprises fluorine, the first halogen content of the gel monolith comprises between approximately 0.1 wt. % fluorine and approximately 10 wt. % fluorine. In other embodiments, the first halogen content of the gel monolith comprises between approximately 3 wt. % fluorine and approximately 8 wt. % fluorine. Upon consolidating the fluorine-doped gel monolith, certain embodiments result in a fluorine-doped glass with between approximately 0.5 wt. % fluorine and approximately 4 wt. % fluorine, while in other embodiments, the fluorine-doped glass has between approximately 0.5 wt. % fluorine and approximately 2.5 wt. % fluorine.

For a 6.35-millimeter-thick portion of the fluorine-doped glass, the glass of certain embodiments has an internal transmittance for 157-nanometer light of at least approximately 80%. In other embodiments, the glass has an internal transmittance for 157-nanometer light through a 6.35-millimeter-thick portion of at least approximately 85%. In still other embodiments, the glass has an internal transmittance for 157-nanometer light through a 6.35-millimeter-thick portion of at least approximately 89%.

In certain embodiments, the resultant glass has an index of refraction that differs from the index of refraction of undoped silica glass. In certain such embodiments, the difference is between approximately 0.001 and approximately 0.012, while in other such embodiments, the difference is between approximately 0.002 and approximately 0.010. In certain embodiments, the resultant glass has a small refractive index inhomogeneity for nonpolarized light. In certain such embodiments, the inhomogeneity is below approximately 100 parts per million, while in other such embodiments, the inhomogeniety is below approximately 10 parts per million. In certain embodiments, the resultant glass has a coefficient of thermal expansion of approximately 5×10⁻⁷ per degree Celsius.

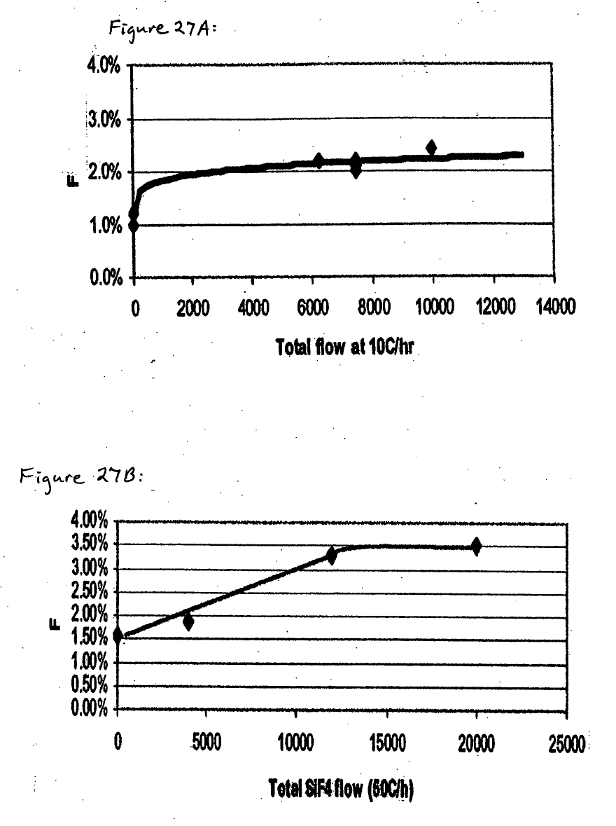

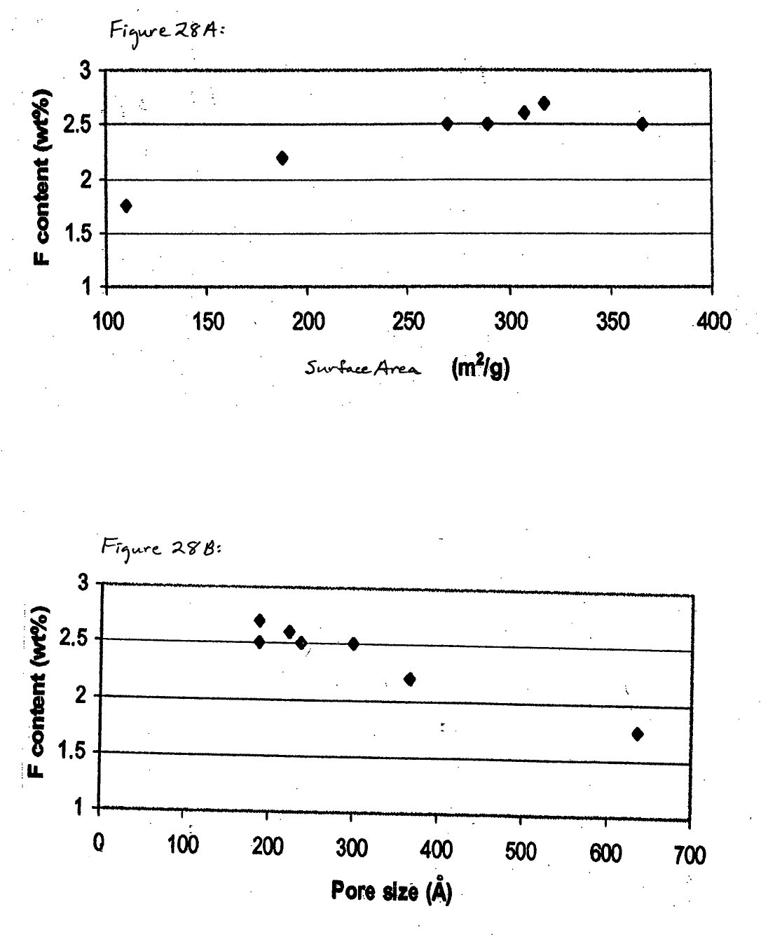

FIGS. 27A and 27B are graphs of the fluorine content (in wt. %) of the resultant glass as a function of the flow rate (in units of cubic centermeter-hours) of SiF₄ gas during the consolidation process. FIG. 27A corresponds to a consolidation temperature ramp rate of approximately 10 degrees Celsius per hour and FIG. 27B corresponds to a ramp rate of approximately 50 degrees Celsius per hour. While there is an apparent saturation effect, both FIGS. 27A and 27B illustrate that larger flows of the SiF₄ gas during consolidation generally result in larger fluorine content in the resultant glass. For example, high SiF₄ flow rates during a consolidation process with a 50 degrees Celsius per hour ramp rate results in a fluorine content of the resultant glass of approximately 3.5 wt. %, as illustrated by FIG. 27B.

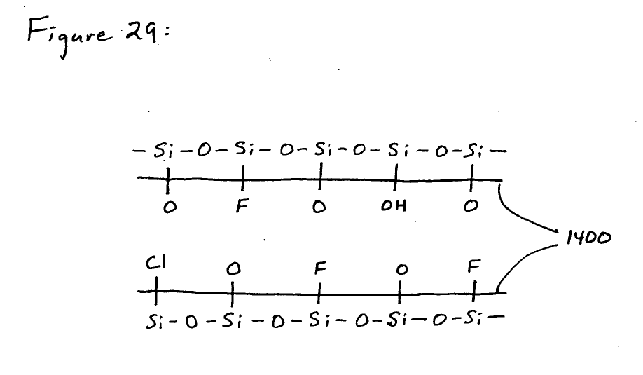

FIG. 28A is a graph of the fluorine content of a glass monolith as a function of the pore surface area of the initial gel monolith without a fluorine-containing atmosphere during consolidation. FIG. 28B is a graph of the fluorine content of a glass monolith as a function of the pore sizes corresponding to the pore surface areas of FIG. 28A. These graphs illustrate that for larger pore surface areas (or smaller pore sizes), the fluorine content of the resultant glass is larger. This correlation between the fluorine content and the pore surface area is a consequence of the fluorine of the gel monolith residing primarily on the pore surfaces.

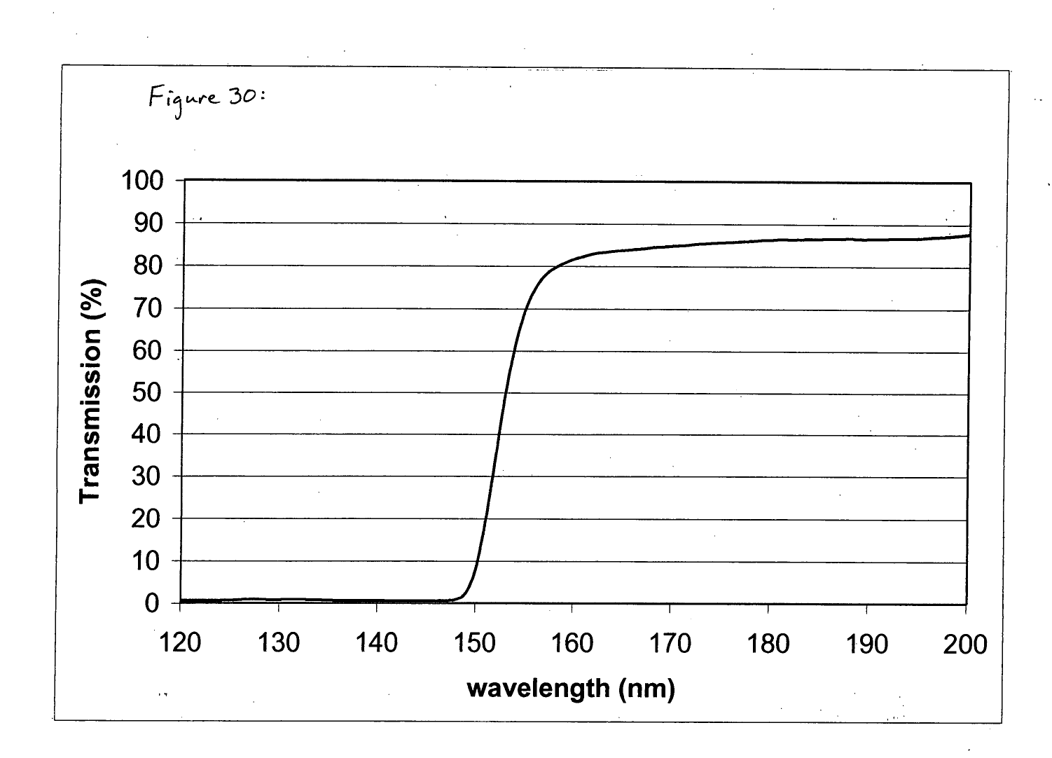

FIG. 29 schematically illustrates a mechanism for fluorine doping of a gel monolith occurring at the pore surfaces 1400. Each silicon atom at the pore surfaces 1400 is bonded to one of the following species: OH, F, O, or Cl. Since the number of possible bonding sites is directly correlated with the pore surface area, the maximum possible fluorine content can be estimated by assuming that each of these bonding sites is bonded to a fluorine atom. Table 2 lists (i) estimations of the fluorine content for various pore surface areas assuming complete saturation at the bonding sites of the pore surfaces [labelled “Est. Max. F Content(wt. %)”]; (ii) estimations of fluorine content assuming SiO_{1.5}F at the bonding sites of the pore surfaces [labelled “Est. F Content with SiO_{1.5}F (wt. %)”]; and (iii) the fluorine content measured for glasses resulting from a consolidation process without a fluorine-containing atmosphere [labelled “Measured F Content (wt. %)”] but with a rapid consolidation temperature ramping rate. As seen in Table 2 and in FIGS. 28A and 28B, the measured fluorine content reaches a saturation level of approximately 2.6 wt. %-2.7 wt. % at higher pore surface areas.

TABLE 2

| Pore S.A. | Est. Max. | Est. F | Measured |
|---|---|---|---|
| (m²/g) at | F Content | Content with | F Content |
| room temp. | (wt. %) | SiO_{1.5}F (wt. %) | (wt. %) |
| 110 | 2.71 | 1.29 | 1.76 |
| 188 | 4.64 | 2.20 | 2.20 |
| 258 | 6.37 | 3.02 | 2.30 |
| 270 | 6.66 | 3.16 | 2.50 |
| 290 | 7.16 | 3.39 | 2.50 |
| 308 | 7.60 | 3.60 | 2.60 |
| 318 | 7.85 | 3.72 | 2.70 |
| 366 | 9.03 | 4.28 | 2.50 |

Table 3 illustrates the optical properties of silica glass monoliths formed using various procedures to demonstrate the relative contributions of the fabrication process to the optical properties of the resultant glass. Table 3 lists the transmission [T(%)], reflectance [R(%)], internal transmission [Internal T (%)], and absorbance [A(%)] for 157 nanometer light with 6.35-millimeter-thick polished but uncoated samples. Table 3 also lists various consolidation parameters, namely, SiF₄ concentration of the consolidation atmosphere [SiF₄ (%)], ramp rate of the consolidation temperature [Ramp Rate (C/hr)], and whether chlorine impurities were removed from the gel monolith [Cl₂ Cleaning]. Table 3 also lists the F content [F (wt. %)] and the OH content in parts-per-billion [OH (ppb)] of the resultant glass after the consolidation process.

TABLE 3

| | | | | | Consolidation Parameters | | | | |
|---|---|---|---|---|---|---|---|---|---|
| | 157 nm light; 6.35 mm thickness | | | | | Ramp | | | |
| | T | R | Internal T | A | SiF₄ | Rate | Cl₂ | F | OH |
| Sample | (%) | (%) | (%) | (%) | (%) | (C/hr) | Cleaning | (wt. %) | (ppb) |
| 1 | 78.469 | 11.149 | 89.618 | 10.382 | 0 | 12.5 | Y | 0.59 | 170 |
| 2 | 79.293 | 10.835 | 90.128 | 9.872 | 50 | 150 | Y | 1.65 | 85 |
| 3 | 61.386 | 9.514 | 70.9 | 29.1 | 0 | 150 | N | 1.86 | 104 |
| 4 | 76.458 | 10.856 | 87.314 | 12.686 | 80 | 22.5 | Y | 3.15 | 170 |

Sample 1 was formed by a consolidation process without exposing the gel monolith to SiF₄, resulting in a fluorine content of 0.59 wt. %. Sample 2 was formed by a consolidation process that exposed the gel monolith to a consolidation atmosphere with 50% SiF₄, resulting in a fluorine content of 1.65 wt. %. Sample 4 was formed by a consolidation process that exposed the gel monolith to a consolidation atmosphere with 80% SiF₄, resulting in a fluorine content of 3.15 wt. %. A comparison of Sample 1, Sample 2, and Sample 4 illustrates that the optical properties (e.g., internal transmission) are not directly proportional to the fluorine content of the resultant glass. For example, even though Sample 1 has a lower fluorine content than Sample 4, it has a higher internal transmission at 157 nm than does Sample 4. Sample 2 has a higher internal transmission at 157 nm than does either Sample 1 or Sample 4, indicating that there is an optimal range of fluorine content between approximately 0.5 wt. % fluorine and approximately 3.0 wt. % fluorine.

The ramp rate of the consolidation temperature can be used to control the fluorine content of the resultant glass, thereby controlling the optical properties of the glass. For example, Sample 2 was formed by a consolidation process with a relatively high consolidation temperature ramp rate, while Sample 4 was formed with a lower consolidation temperature ramp rate. With its quicker ramp rate, Sample 4 had a higher fluorine content than did Sample 2.

The highest internal transmission at 157 nanometers was observed for Sample 2, which had a fluorine content of 1.65 wt. %. This result was achieved by exposing the gel monolith to a consolidation atmosphere containing SiF₄ and a relatively high ramp rate of the consolidation temperature. FIG. 30 is a graph of an exemplary measured transmission spectrum for the fluorine-doped silica glass corresponding to Sample 2 of Table 3.

A comparison of Sample 3 with the other samples illustrates the significance of removing the chlorine impurities from the gel monolith prior to consolidation. Sample 3 was formed using exposure to chlorine to remove OH impurities from the gel monolith pores, but the gel monolith was not subsequently exposed to oxygen to remove chlorine from the pores. The remaining chlorine on the pore surfaces of the gel monolith was then incorporated into the glass resulting from the consolidation process. This chlorine significantly reduced the internal transmission of Sample 3 as compared to what would be expected from a glass having the fluorine content of Sample 3, namely, 1.86 wt. %.

### EXAMPLE 3

### Fluorine-Doped Glass

In an exemplary embodiment to form a fluorine-doped glass, a first substance is prepared by mixing approximately 1247 grams (6.5 moles) of triethoxyfluorosilane (TEOF) of 95% purity, approximately 4066 grams (19.5 moles) of tetraethylorthosilicate (TEOS), and approximately 3833 grams (83 moles) of reagent alcohol. A second substance is prepared by mixing approximately 848 grams (47 moles) of deionized water, approximately 104 grams of 50% HF solution (2.6 moles of HF), and approximately 958 grams (21 moles) of reagent alcohol. Both the first and second substances are stored at approximately −80 degrees Celsius for approximately 24 hours and the mixing bath is maintained at approximately −10 degrees Celsius.

The second substance is added to the first substance within approximately one minute with continuous stirring, to form the solution. After stirring for approximately 9 minutes more, the resulting homogeneously translucent solution is filtered using a 0.1 micron filter, and is cast into a mold. The solution is allowed to gel for approximately 10 minutes, at which point, a thin layer of reagent alcohol is placed on the gel to protect the gel from excessive drying and cracking due to contact with air. The resultant bubble- and particle-free wet gel monolith is aged at room temperature (approximately 26 degrees Celsius) for approximately three days.

The wet gel monolith is then dried using the temporal temperature profile procedure described above at approximately one atmosphere and at temperatures less than approximately 200 degrees Celsius. In certain embodiments, the temporal temperature profile is tailored to provide a resultant pore diameter distribution with a mean pore diameter in the range from approximately 100 Å to approximately 1000 Å.

The dried gel monolith is then transferred to the high temperature furnace for consolidation by ramping the temperature to a temperature above 1200 degrees Celsius. Remaining organic and solvent molecules adsorbed on the surfaces of the gel monolith can be burned off by heating to a temperature at approximately 400-500 degrees Celsius in an atmosphere of nitrogen and oxygen.

To reduce the loss of fluorine from the gel monolith during the consolidation process, a mixture of SiF₄ and helium is introduced in the furnace upon reaching a temperature of approximately 400-500 degrees Celsius. Immediately before gel densification, the SiF₄ flow can be stopped and the helium flow continued while the gel becomes fully densified at temperatures above 1200 degrees Celsius. After consolidation, the fluorine-doped glass monolith is cooled down to room temperature.

Although described above in connection with particular embodiments of the present invention, it should be understood the descriptions of the embodiments and examples are illustrative of the invention and are not intended to be limiting. Various modifications and applications may occur to those skilled in the art without departing from the true spirit and scope of the invention as defined in the appended claims.

What is claimed is:

1. A method of fabricating a halogen-doped glass, the method comprising:
providing a gel monolith having a first halogen content;
reducing an impurity concentration of the gel monolith; and
consolidating the gel monolith into a glass having a second halogen content, the second halogen content being less than or equal to the first halogen content.

2. The method of claim 1, wherein providing the sol-gel monolith comprises forming the sol-gel monolith by:
preparing a first substance comprising metal alkoxide;
preparing a second substance comprising a catalyst;
providing a halogen-comprising chemical;
forming a solution comprising the halogen by mixing the first solution and the second solution together with the halogen-comprising chemical;
cooling the solution to a mixture temperature which is substantially below room temperature, wherein the solution has a significantly longer gelation time at the mixture temperature as compared to a room temperature gelation time for the solution;
allowing the solution to gel, thereby forming a wet gel monolith; and
drying the wet gel monolith.

3. The method of claim 1, wherein reducing the impurity concentration comprises reducing a hydroxyl impurity concentration of the gel monolith by heating the gel monolith at a first elevated temperature while the gel monolith is exposed to a first atmosphere having a chlorine (Cl₂) concentration.

4. The method of claim 3, wherein the first elevated temperature is between approximately 400 degrees Celsius and approximately 1000 degrees Celsius.

5. The method of claim 3, wherein the first elevated temperature is between approximately 400 degrees Celsius and approximately 700 degrees Celsius.

6. The method of claim 3, wherein the first elevated temperature is ramped.

7. The method of claim 3, wherein the first atmosphere has a pressure less than atmospheric pressure.

8. The method of claim 7, wherein the chlorine concentration is between approximately 3% and approximately 20%.

9. The method of claim 7, wherein the chlorine concentration is approximately 10%.

10. The method of claim 3, wherein reducing the impurity concentration further comprises reducing a chlorine impurity concentration of the gel monolith.

11. The method of claim 10, wherein reducing the chlorine impurity concentration of the gel monolith comprises heating the gel monolith at a second elevated temperature while the gel monolith is exposed to a second atmosphere having an oxygen (O₂) concentration.

12. The method of claim 11, wherein the second elevated temperature is between approximately 700 degrees Celsius and approximately 950 degrees Celsius.

13. The method of claim 11, wherein the second elevated temperature is ramped.

14. The method of claim 11, wherein the second atmosphere has a pressure less than atmospheric pressure.

15. The method of claim 14, wherein the oxygen concentration is between approximately 30% and approximately 100%.

16. The method of claim 14, wherein the oxygen concentration is approximately 50%.

17. The method of claim 1, wherein the gel monolith comprises pores with an average pore diameter between approximately 10 nanometers and approximately 100 nanometers.

18. The method of claim 1, wherein the gel monolith comprises pores with an average surface area between approximately 80 square meters per gram and approximately 700 square meters per gram.

19. The method of claim 1, wherein the halogen comprises iodine.

20. The method of claim 1, wherein the halogen comprises bromine.

21. The method of claim 1, wherein the halogen comprises fluorine.

22. The method of claim 21, wherein the first halogen content of the gel monolith comprises between approximately 0.1% fluorine and approximately 10% fluorine.

23. The method of claim 21, wherein the first halogen content of the gel monolith comprises between approximately 3% fluorine and approximately 8% fluorine.

24. The method of claim 21, wherein the second halogen content of the glass comprises between approximately 0.5 wt. % fluorine and approximately 4 wt. % fluorine.

25. The method of claim 21, wherein the second halogen content of the glass comprises between approximately 0.5 wt. % fluorine and approximately 2.5 wt. % fluorine.

26. The method of claim 1, wherein the halogen comprises fluorine and consolidating the gel monolith comprises ramping the temperature of the gel monolith at a ramp rate such that the second halogen content of the glass is at least approximately 0.5 wt. % fluorine.

27. The method of claim 26, wherein the ramp rate is between approximately 10 degrees Celsius per hour and approximately 150 degrees Celsius per hour.

28. The method of claim 1, wherein the halogen comprises fluorine and consolidating the gel monolith comprises heating the gel monolith to an elevated temperature while being exposed to an atmosphere comprising a fluorine-containing gas concentration.

29. The method of claim 28, wherein the fluorine-containing gas comprises one or more of the following gases: SiF₄, SiHF₃, SiH₂F₂, SiH₃F, CF₄, CHF₃, CH₂F₂, CH₃F, C₂F₆, C₂HF₅, C₂H₂F₄, C₂H₃F₃, C₂H₄F₂, C₂H₅F, SF₆, SHF₅, SH₂F₄, SH₃F₃, SH₄F₂, SH₅F, HF, and F₂.

30. The method of claim 28, wherein the atmosphere has a pressure less than atmospheric pressure.

31. The method of claim 30, wherein the fluorine-containing gas concentration is between approximately 10% and approximately 80%.

32. The method of claim 30, wherein the fluorine-containing gas concentration is between approximately 20% and approximately 50%.

33. The method of claim 30, wherein the fluorine-containing gas concentration is sufficient to reduce liberation of fluorine from the gel monolith during consolidation.

34. The method of claim 28, wherein the elevated temperature is between approximately 800 degrees Celsius and approximately 1250 degrees Celsius.

35. The method of claim 28, wherein the elevated temperature is between approximately 950 degrees Celsius and approximately 1100 degrees Celsius.

36. The method of claim 28, wherein the elevated temperature is ramped.

37. The method of claim 1, wherein the glass has an internal transmission at 157 nanometers of at least approximately 80% through 6.35 millimeters of glass.

38. The method of claim 1, wherein the glass has an internal transmission at 157 nanometers of at least approximately 85% through 6.35 millimeters of glass.

39. The method of claim 1, wherein the glass has an internal transmission at 157 nanometers of at least approximately 89% through 6.35 millimeters of glass.

40. The method of claim 1, wherein the glass has an index of refraction difference from undoped silica glass of between approximately 0.001 and approximately 0.012.

41. The method of claim 1, wherein the glass has an index of refraction difference from undoped silica glass of between approximately 0.002 and approximately 0.010.

42. The method of claim 1, wherein the glass has an OH content below approximately one part per million.

43. The method of claim 1, wherein the glass has a refractive index inhomogeneity for nonpolarized light below approximately 100 parts per million.

44. The method of claim 1, wherein the glass has a refractive index inhomogeneity for polarized light below approximately 10 parts per million.

45. The method of claim 1, wherein the glass has a coefficient of thermal expansion of approximately 5×10⁻⁷ per degree Celsius.

46. A method of forming a halogen-doped glass, the method comprising:
providing a gel monolith having a first halogen content;
reducing an impurity concentration of the gel monolith; and
heating the gel monolith to an elevated temperature sufficient to sinter the gel monolith into a glass having a second halogen content less than or equal to the first halogen content.

47. The method of claim 46, wherein heating the gel monolith comprises ramping the temperature of the gel monolith at a ramp rate such that the second halogen content is above a preselected value.

48. The method of claim 47, wherein heating the gel monolith further comprises exposing the gel monolith to an atmosphere comprising a halogen-containing gas

49. The method of claim 46, wherein reducing the impurity concentration of the gel monolith comprises:
reducing a hydroxyl impurity concentration of the gel monolith by heating the gel monolith at a first elevated temperature while the gel monolith is exposed to a first atmosphere having a chlorine (Cl₂) concentration; and
reducing a chlorine impurity concentration of the gel monolith by heating the gel monolith at a second elevated temperature while the gel monolith is exposed to a second atmosphere having an oxygen (O₂) concentration.

50. A method of fabricating a halogen-doped glass, the method comprising:
consolidating a gel monolith having a halogen content; and
reducing the liberation of halogen from the gel monolith during the consolidation by exposing the gel monolith to a halogen-containing gas during the consolidation.

51. The method of claim 50, wherein the halogen comprises fluorine.

52. A method of fabricating a fluorine-doped silica glass, the method comprising consolidating a gel monolith having a fluorine content in an environment with an elevated fluorine partial pressure.

53. A silica glass having a fluorine content in a range between approximately 0.5 wt. % and approximately 4 wt. %, a chlorine content less than 100 parts per million, and an OH content less than one part per million.
